(19) United States
(12) Patent Application Publication
(10) Pub. No.: US 2007/0200726 A1
(43) Pub. Date: Aug. 30, 2007

(54) Apparatus and method to display information in a swimming pool

(76) Inventor: Ernest A. Harvin, Sierra Vista, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/705,966

(22) Filed: Feb. 14, 2007

Related U.S. Application Data
(60) Provisional application No. 60/773,175, filed on Feb. 14, 2006.

(51) Int. Cl. G09F 9/33

(52) U.S. Cl. 340/815.45

(57) ABSTRACT

An apparatus and method is disclosed to display visual information in a swimming pool at least partially filled with water. The method disposes a plurality of light emitting devices on a surface of a swimming pool comprising a length, a plurality of sides and a bottom, wherein the surface is selected from the group consisting of one or more of the plurality of sides and the bottom. The method further sequentially energizes one or more of the light emitting devices.

### CROSS-REFERENCE TO RELATED APPLICATION

This Application claims priority from a U.S. Provisional Application having Ser. No. 60/773,175 filed on Feb. 14, 2006.

### FIELD OF THE INVENTION

Applicant's invention comprises a method to display information in a swimming pool. In certain embodiments, the information comprises visual information. In certain embodiments, the information comprises audible information.

### BACKGROUND OF THE INVENTION

It is known in the art to display signs, banners, electronic displays, and the like, at or near a swimming pool. It is further known in the art to play music in near vicinity to a swimming pool.

### SUMMARY OF THE INVENTION

Applicant's invention comprises an apparatus and method to display visual information in a swimming pool at least partially filled with water. The method disposes a plurality of light emitting devices on a surface of a swimming pool comprising a length, a plurality of sides and a bottom, wherein the surface is selected from the group consisting of one or more of the plurality of sides and the bottom. The method further sequentially energizes one or more of the light emitting devices.

### BRIEF DESCRIPTION OF THE DRAWINGS

The invention will be better understood from a reading of the following detailed description taken in conjunction with the drawings in which like reference designators are used to designate like elements, and in which:

FIG. 1A is a perspective view of a swimming pool without water;

FIG. 1B is a top view of a pool surface showing a plurality of visual display devices disposed on that surface;

FIG. 2 shows a first visual display device being energized;

FIG. 3 shows a second visual display device being energized;

FIG. 4 shows a third visual display device being energized;

FIG. 5 shows a fourth visual display device being energized;

FIG. 6 shows a fifth visual display device being energized;

FIG. 7 shows a sixth visual display device being energized;

FIG. 8 shows a seventh visual display device being energized;

FIG. 9 shows an eighth visual display device being energized;

FIG. 10 shows a ninth visual display device being energized;

FIG. 11 shows a tenth visual display device being energized;

FIG. 12 shows an eleventh visual display device being energized;

FIG. 13 shows a twelfth visual display device being energized;

FIG. 14 shows a thirteenth visual display device being energized;

FIG. 15 shows the thirteenth visual display device again being energized;

FIG. 16 shows the twelfth visual display device again being energized;

FIG. 17 shows the eleventh visual display device again being energized;

FIG. 18 shows the tenth visual display device again being energized;

FIG. 19 shows the ninth visual display device again being energized;

FIG. 20 shows the eighth visual display device again being energized;

FIG. 21 shows the seventh visual display device again being energized;

FIG. 22 shows the sixth visual display device again being energized;

FIG. 23 shows the fifth visual display device again being energized;

FIG. 24 shows the fourth visual display device again being energized;

FIG. 25 shows the third visual display device again being energized;

FIG. 26 shows the second visual display device again being energized;

FIG. 27 shows the first visual display device again being energized;

FIG. 28A shows a side view of a first embodiment of a first multi-lens visual display device;

FIG. 28B shows a first perspective view of the multi-lens visual display device of FIG. 28A;

FIG. 28C shows a second perspective view of the multi-lens visual display device of FIG. 28A;

FIG. 28D shows a side view of a second embodiment of the first multi-lens visual display device;

FIG. 28E shows a first perspective view of the multi-lens visual display device of FIG. 28D;

FIG. 28F shows a second perspective view of the multi-lens visual display device of FIG. 28D;

FIG. 29 is a top view showing a plurality of visual display devices of FIGS. 28A, 28B, and 28C, in combination with a plurality of visual display devices of FIGS. 28D, 28E, and 28F;

FIG. 30 shows the apparatus of FIG. 29 wherein a first visual display device of FIGS. 28A, 28B, and 28C is illuminated;

FIG. 31 shows the apparatus of FIG. 29 wherein a second visual display device of FIGS. 28A, 28B, and 28C is illuminated;

FIG. 32 shows the apparatus of FIG. 29 wherein a third visual display device of FIGS. 28A, 28B, and 28C is illuminated;

FIG. 33 shows the apparatus of FIG. 29 wherein a fourth visual display device of FIGS. 28A, 28B, and 28C is illuminated;

FIG. 34 shows the apparatus of FIG. 29 wherein a fifth visual display device of FIGS. 28A, 28B, and 28C is illuminated;

FIG. 35 shows the apparatus of FIG. 29 wherein a sixth visual display device of FIGS. 28A, 28B, and 28C is illuminated;

FIG. 36 shows the apparatus of FIG. 29 wherein a first visual display device of FIGS. 28D, 28E, and 28F is illuminated;

FIG. 37 shows the apparatus of FIG. 29 wherein a second visual display device of FIGS. 28D, 28E, and 28F is illuminated;

FIG. 38 shows the apparatus of FIG. 29 wherein a third visual display device of FIGS. 28D, 28E, and 28F is illuminated;

FIG. 39 shows the apparatus of FIG. 29 wherein a fourth visual display device of FIGS. 28D, 28E, and 28F is illuminated;

FIG. 40 shows the apparatus of FIG. 29 wherein a fifth visual display device of FIGS. 28D, 28E, and 28F is illuminated;

FIG. 41 shows the apparatus of FIG. 29 wherein a sixth visual display device of FIGS. 28D, 28E, and 28F is illuminated;

FIG. 42A is a perspective view showing a visual display device comprising a plurality of light-emitting devices disposed on the bottom of a swimming pool;

FIG. 42B is a perspective view showing a visual display device comprising a plurality of light-emitting devices disposed on a side of a swimming pool;

FIG. 42C is a top view of a visual display comprising a plurality of light-emitting devices disposed on a pool surface, such as a side or bottom;

FIG. 43A shows a stick figure of a swimmer displayed at a first location on the visual display device of FIG. 42C;

FIG. 43B shows two stick figures representing two swimmers displayed at first locations on the visual display device of FIG. 42C;

FIG. 44A shows a stick figure of a swimmer displayed at a second location on the visual display device of FIG. 42C;

FIG. 44B shows two stick figures representing two swimmers displayed at second locations on the visual display device of FIG. 42C;

FIG. 45A shows a stick figure of a swimmer displayed at a third location on the visual display device of FIG. 42C;

FIG. 45B shows two stick figures representing two swimmers displayed at third locations on the visual display device of FIG. 42C;

FIG. 46A shows a stick figure of a swimmer displayed at a fourth location on the visual display device of FIG. 42C;

FIG. 46B shows two stick figures representing two swimmers displayed at fourth locations on the visual display device of FIG. 42C;

FIG. 47A shows a stick figure of a swimmer displayed at a fifth location on the visual display device of FIG. 42C;

FIG. 47B shows two stick figures representing two swimmers displayed at fifth locations on the visual display device of FIG. 42C;

FIG. 48A shows a stick figure of a swimmer displayed at a sixth location on the visual display device of FIG. 42C;

FIG. 48B shows two stick figures representing two swimmers displayed at sixth locations on the visual display device of FIG. 42C;

FIG. 49A shows a stick figure of a swimmer displayed at a seventh location on the visual display device of FIG. 42C;

FIG. 49B shows two stick figures representing two swimmers displayed at seventh locations on the visual display device of FIG. 42C;

FIG. 50A shows a stick figure of a swimmer displayed at an eighth location on the visual display device of FIG. 42C;

FIG. 50B shows two stick figures representing two swimmers displayed at eighth locations on the visual display device of FIG. 42C;

FIG. 51A shows a stick figure of a swimmer displayed at a ninth location on the visual display device of FIG. 42C;

FIG. 51B shows two stick figures representing two swimmers displayed at ninth locations on the visual display device of FIG. 42C;

FIG. 52A shows a stick figure of a swimmer displayed at a tenth location on the visual display device of FIG. 42C;

FIG. 52B shows two stick figures representing two swimmers displayed at tenth locations on the visual display device of FIG. 42C;

FIG. 53A shows a first perspective view of a first embodiment of Applicant's floatable buoy device comprising a plurality of lens elements;

FIG. 53B shows a second perspective view of a first embodiment of Applicant's floatable buoy device comprising a plurality of lens elements;

FIG. 53C shows a first perspective view of a second embodiment of Applicant's floatable buoy device comprising a plurality of lens elements;

FIG. 53D shows a second perspective view of a second embodiment of Applicant's floatable buoy device comprising a plurality of lens elements; and

FIG. 54 shows a plurality of floatable buoys of FIGS. 53A and 53B in combination with a plurality of floatable buoys of FIGS. 53C and 53D.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

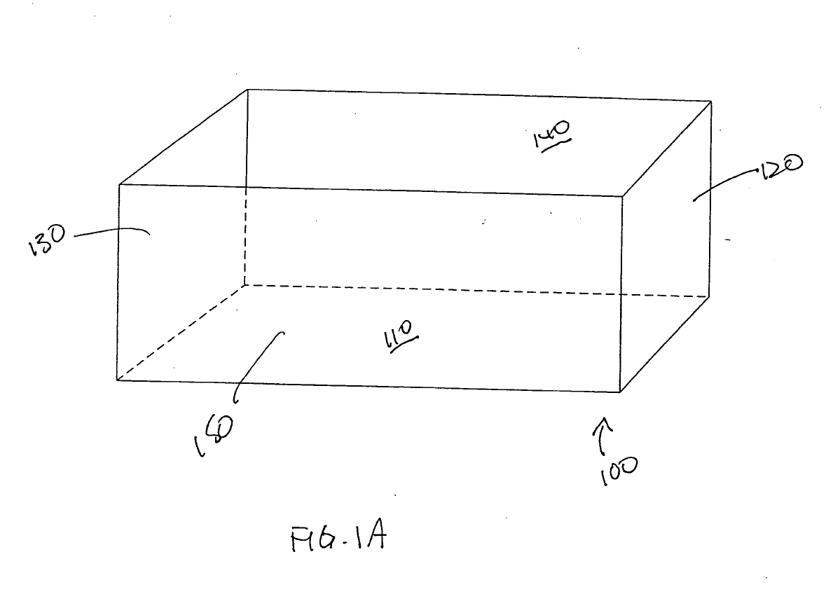

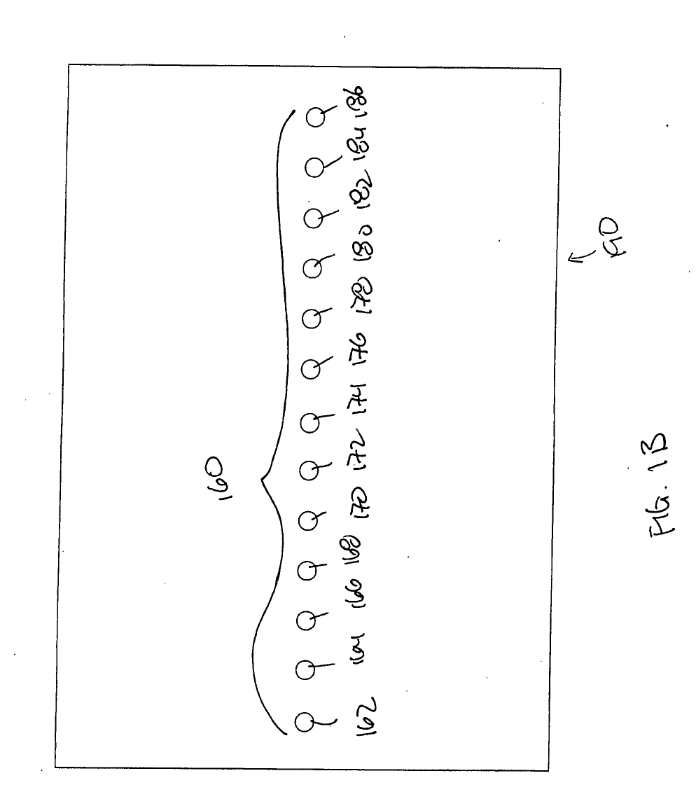

Referring now to FIG. 1A, swimming pool 100 comprises bottom 110, and four sides 120, 130, 140, and 150. Applicant's invention comprises one or more visual display devices disposed in a swimming pool, and associated controllers, software, and firmware, to selectively illuminate all or part of those one or more visual display devices.

Applicant's invention can be implemented in a swimming pool of any configuration and dimension. For clarity of illustration, no water is shown in swimming pool 100 in the illustrated embodiment of FIG. 1A. As those skilled in the art will appreciate, in order to be used for water sports, water is disposed in pool 100, wherein the amount of water is selected based upon the volume of the pool, the desired depth of water, and the like.

In the illustrated embodiment of FIG. 1B, pool surface 190 comprises a plurality of visible light emitting devices 160. Further in the illustrated embodiment of FIG. 1B, pool surface 190 comprises visible light emitting devices 162, 164, 166, 168, 170, 172, 174, 176, 178, 180, 182, 184, and 186. Applicant's visible light emitting devices are designed for use underwater.

U.S. Pat. No. 6,184,628, in the name of Ruthenberg, and hereby incorporated herein, teaches multicolor LED assemblies, wherein those visible light emitting assemblies can be used as underwater pool lights. U.S. Pat. No. 5,299,043, in the name of Taylor et al., and hereby incorporated herein, teaches a display apparatus for underwater use. In certain embodiments, Applicant's plurality of visible light emitting devices comprises one or more LED assemblies taught by Ruthenberg et al. In certain embodiments, Applicant's plurality of visible light emitting devices comprises one or more display apparatus taught by Taylor et al.

In certain embodiments, pool surface 190 comprise a bottom element, such as bottom 110 (FIG. 1A). In certain embodiments, pool surface 190 comprises a side element, such as side 140 (FIG. 1A) and/or side 150 (FIG. 1A). The number of visible light emitting devices can be adjusted based upon, inter alia, the length of the pool.

Applicant's invention comprises a training method for competitive swimmers. Using Applicant's method, plurality of visible light emitting devices 160 (FIG. 1B) are caused to sequentially illuminate for a short period of time. In certain embodiments, the illumination period is about 1 second. In certain embodiments, the illumination period is about 2 seconds. In certain embodiments, the illumination period is adjustable to be between about 1 second and about 5 seconds.

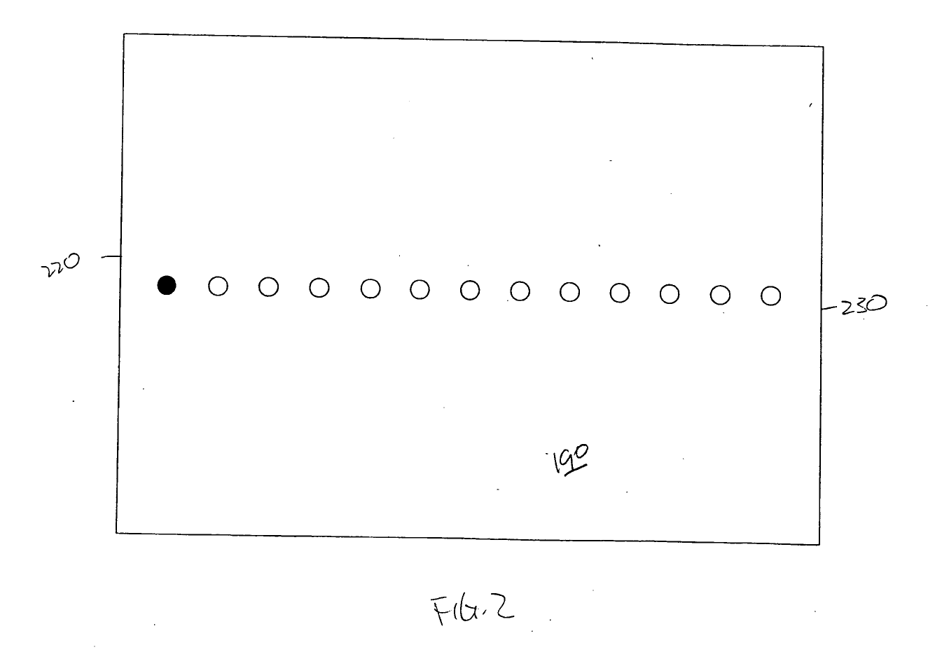

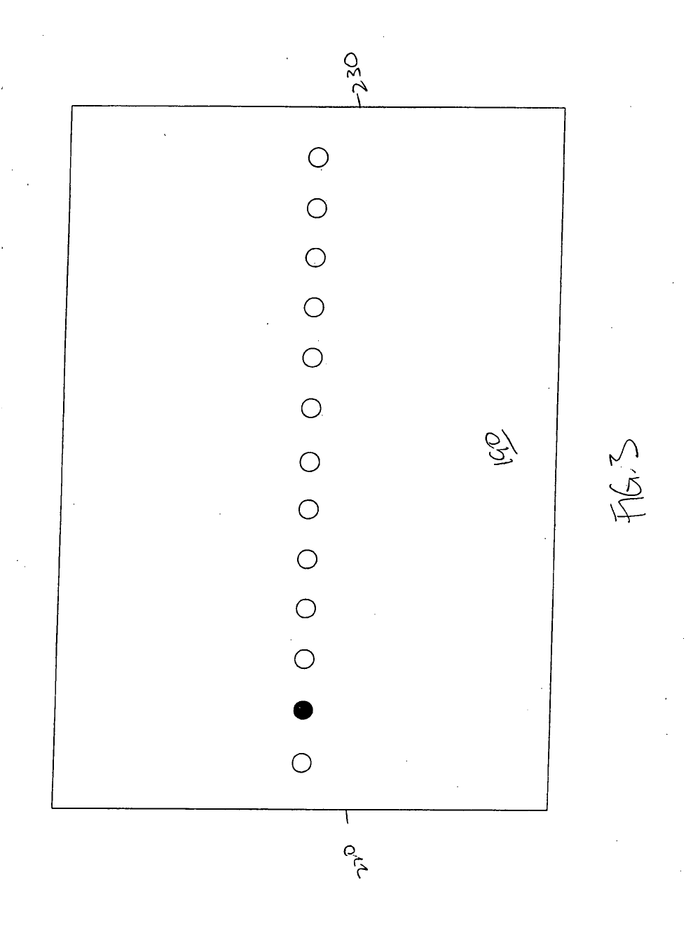

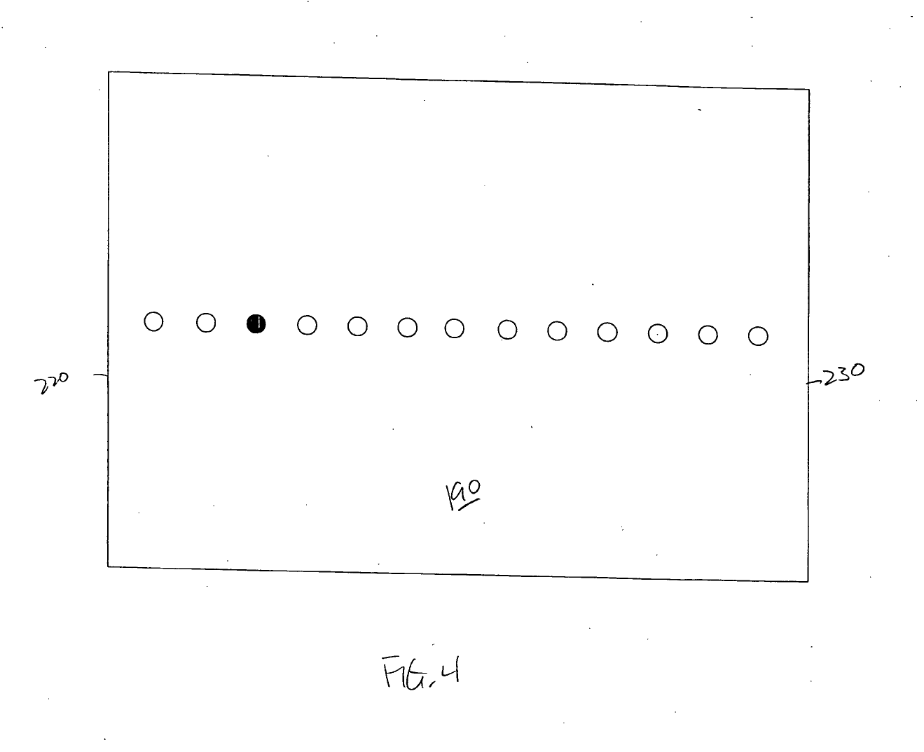

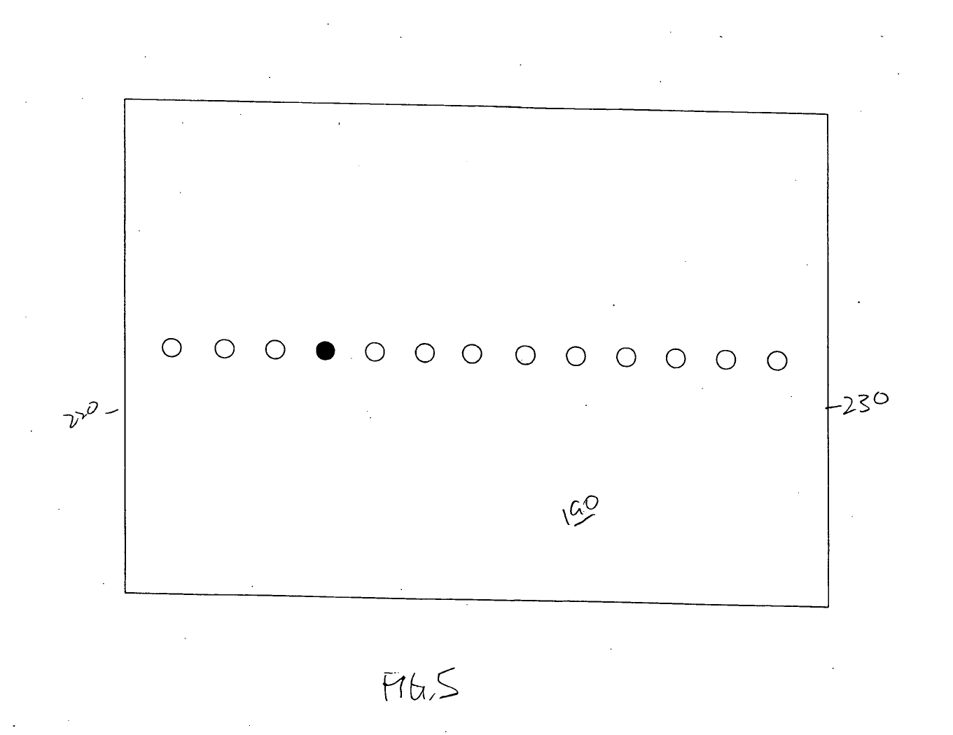

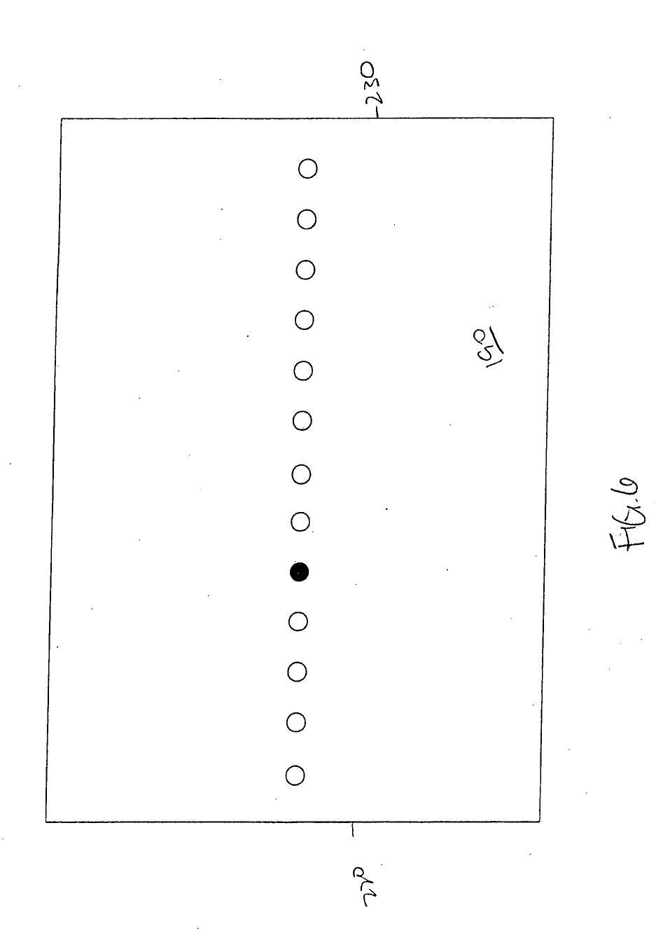

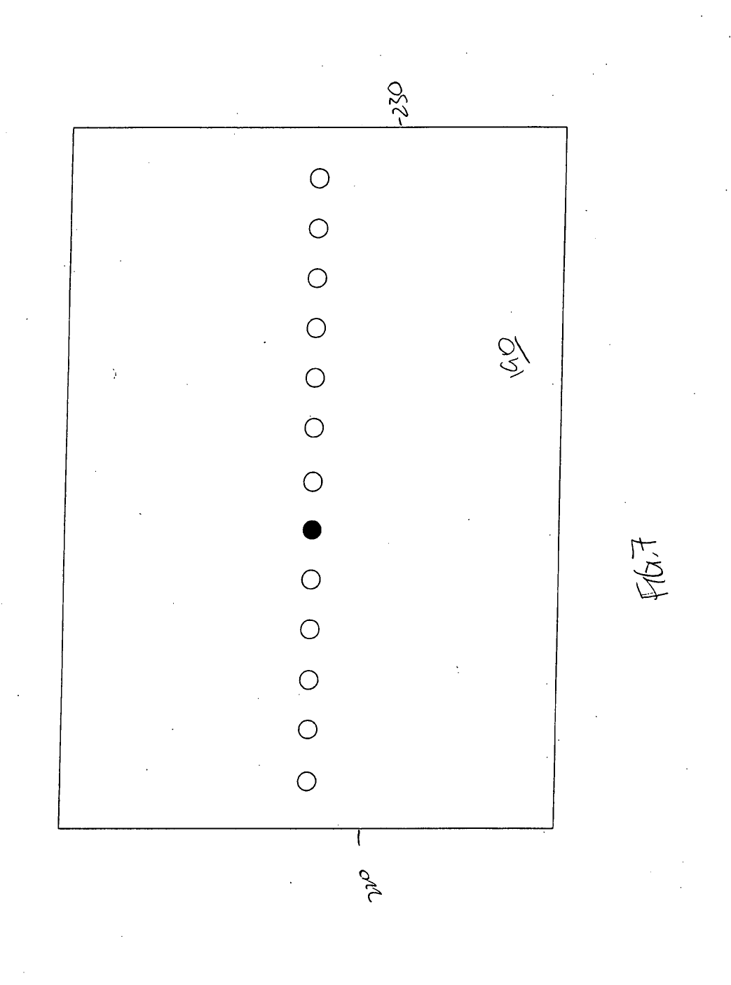

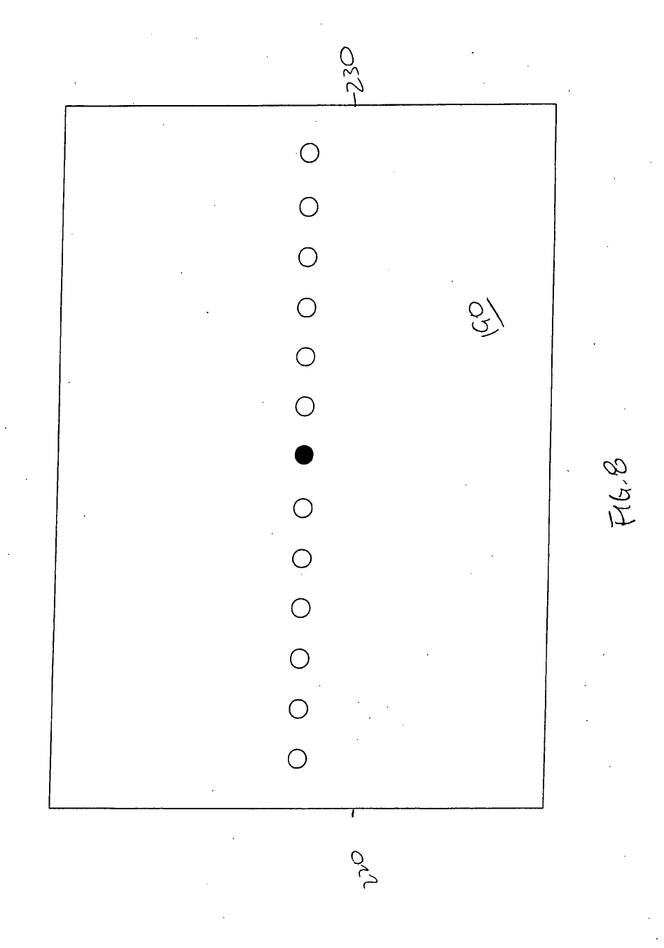

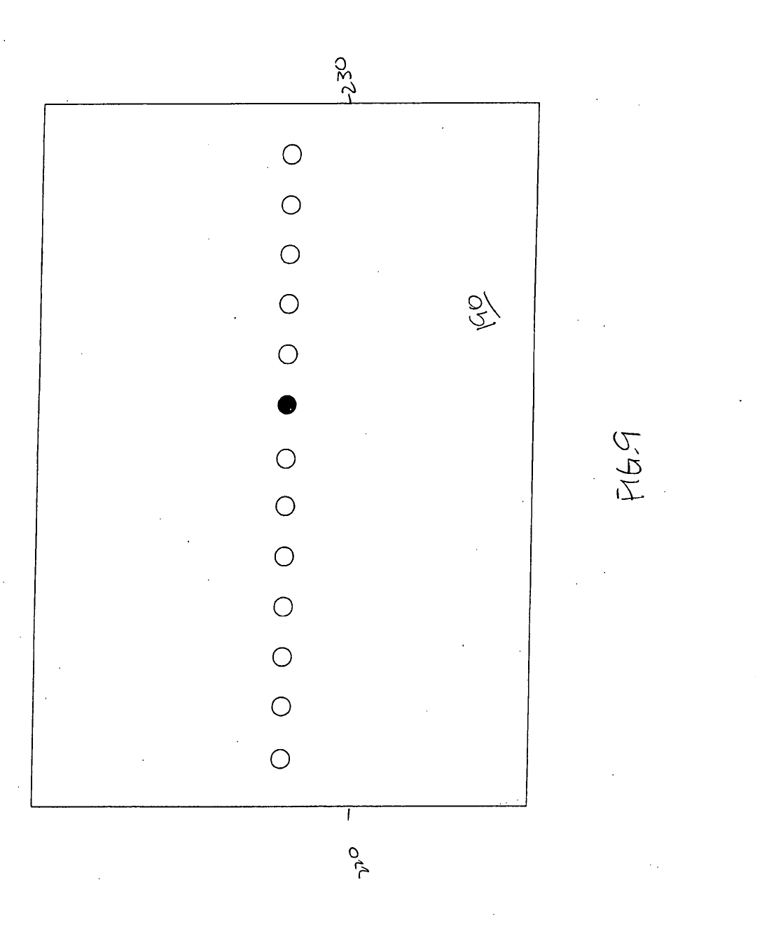

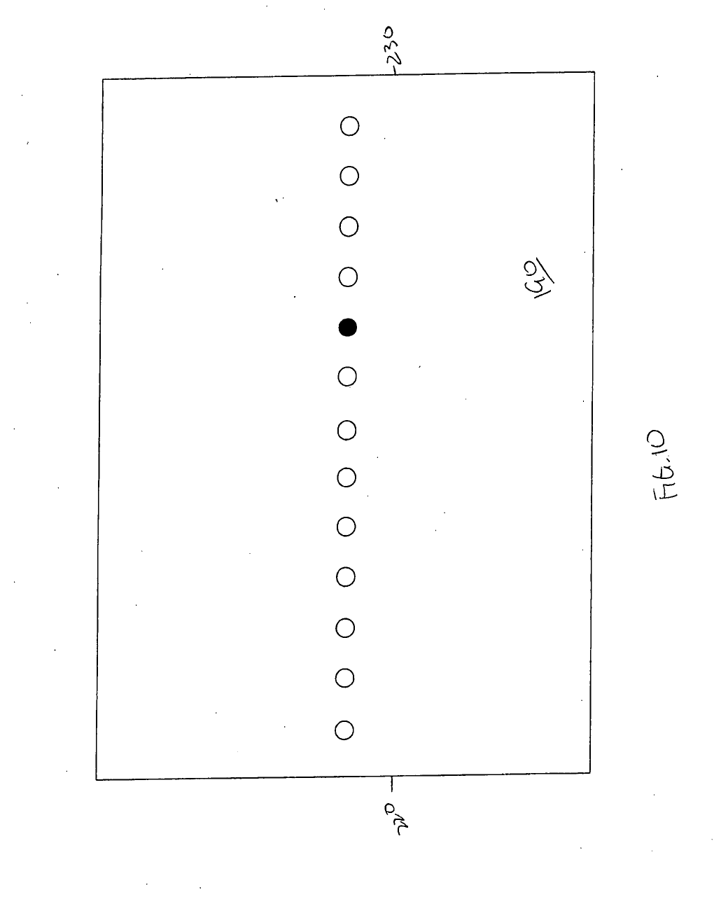

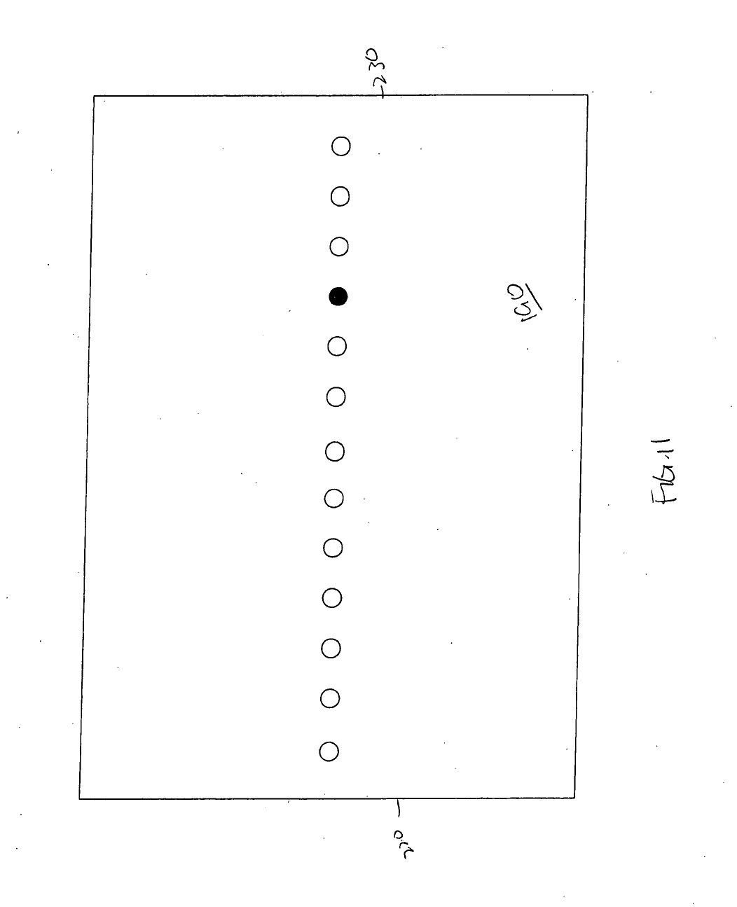

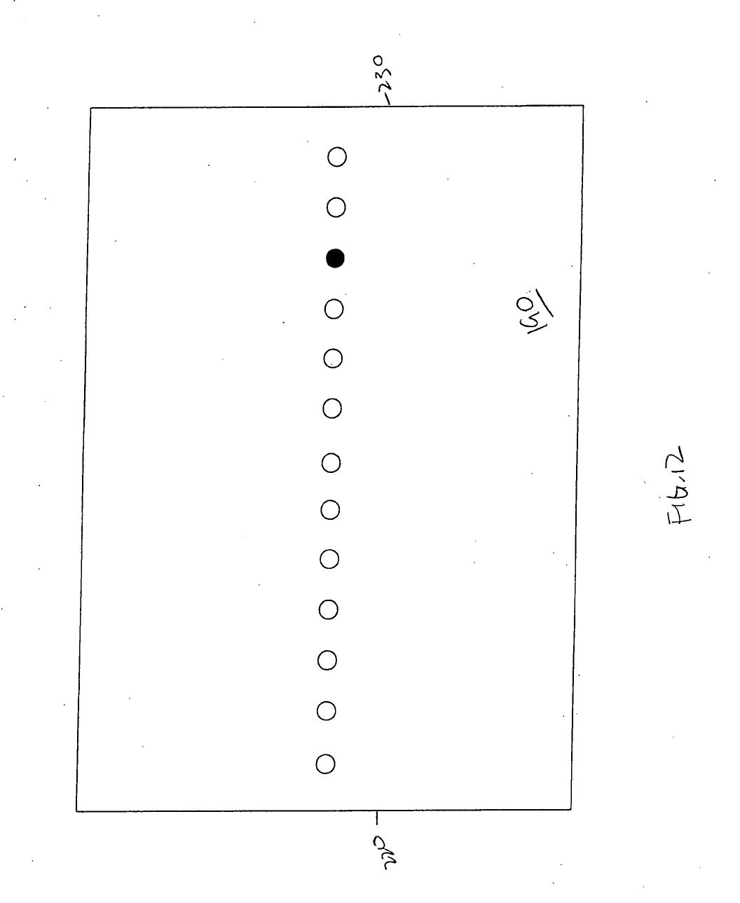

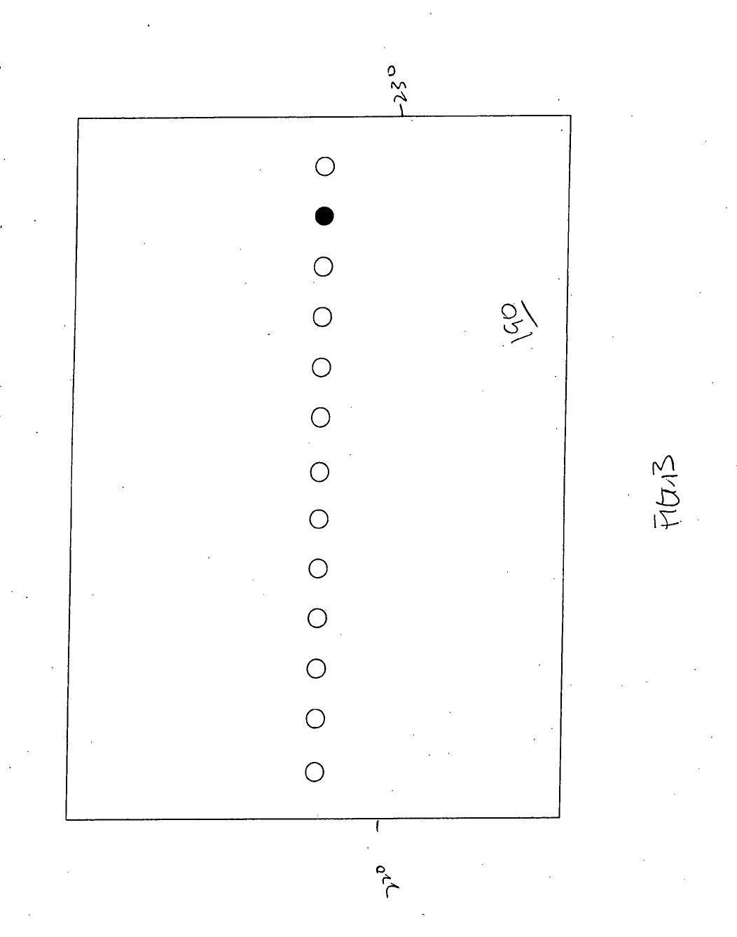

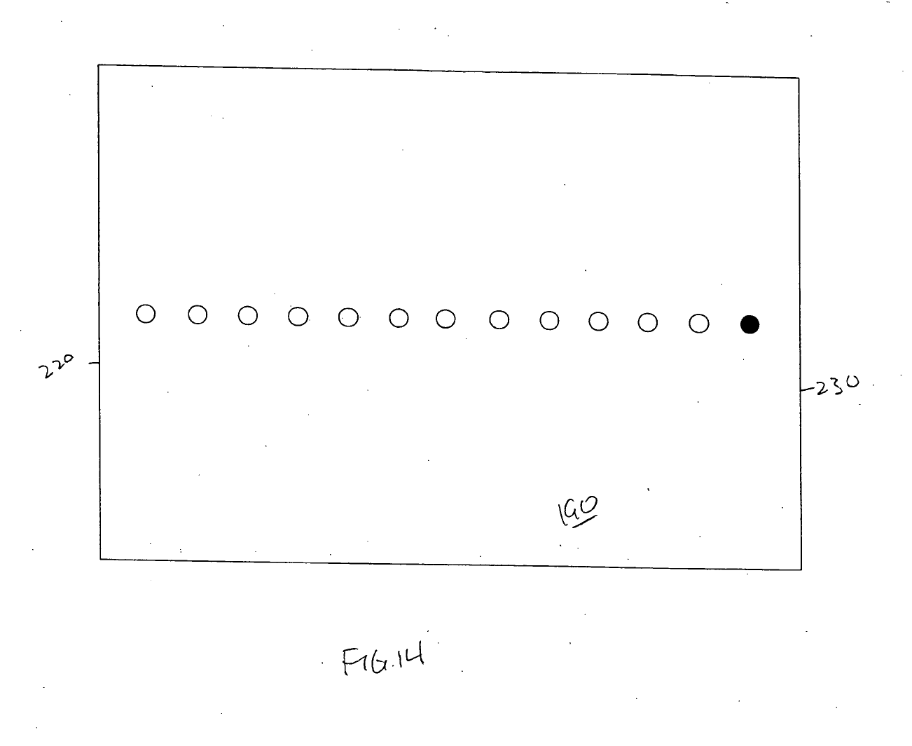

Applicant's apparatus and method allows a swimmer, or the swimmer's coach, to adjust the timing at which the plurality of visible light emitting devices 160 emit visual light. For example, as shown in FIGS. 2 through 15, visible light emitting devices 162, 164, 166, 168, 170, 172, 174, 176, 178, 180, 182, 184, and 186, are sequentially energized, and thereby sequentially emit visible light for the selected illumination period. For the sake of clarity, FIGS. 2 through 15 show one linear pattern of visible light emitting devices. As those skilled in the art will appreciate, visible light emitting devices 162, 164, 166, 168, 170, 172, 174, 176, 178, 180, 182, 184, and 186, can be disposed in one or more of (N) swimming lanes in a pool, wherein (N) is greater than or equal to 1.

The swimmer/coach can adjust the timing of the sequential illumination of plurality of devices 160. In certain embodiments of Applicant's method, the same time interval is used between each of the plurality of visible light emitting devices 160. In other embodiments of Applicant's invention, the time interval between each (i)th visible light emitting device and the (i+1)th visible light emitting device can be separately adjusted.

The swimmer then attempts to swim a first lap from side 220 to side 230 such that he/she passes over each illumination device exactly at the time that device is energized and emits light. After the swimmer can successfully swim the selected distance and pass over each device just as the device is illuminated, then the swimmer/coach can adjust the timing to cause the plurality of visible light emitting devices to energize at a faster rate thereby causing the swimmer to swim the selected distance in a shorter period of time.

In certain embodiments, Applicant's plurality of light emitting devices comprise (N) light emitting devices, and Applicant's method comprises the steps of creating a training regime whereunder a swimmer swims the length of a pool in a defined time interval (T), energizing the (i)th light emitting device, wherein (i) is initially set to 1, for a time interval equal to (T)/(N), determining if (i) equals (N), operative if (i) does not equal (N), incrementing (i) by unity and repeating the energizing and the determining steps.

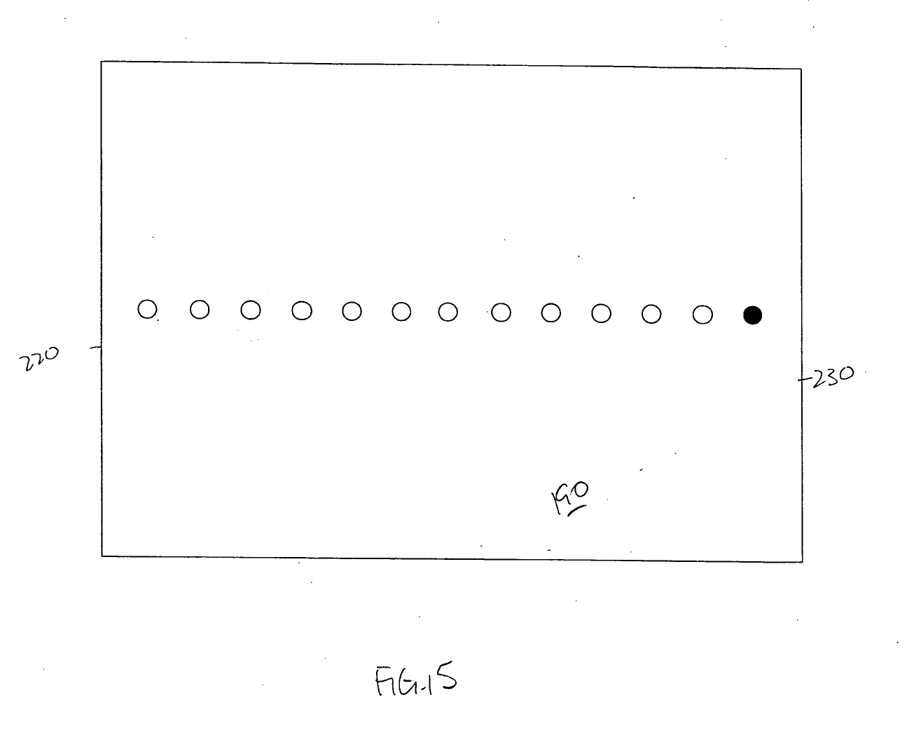

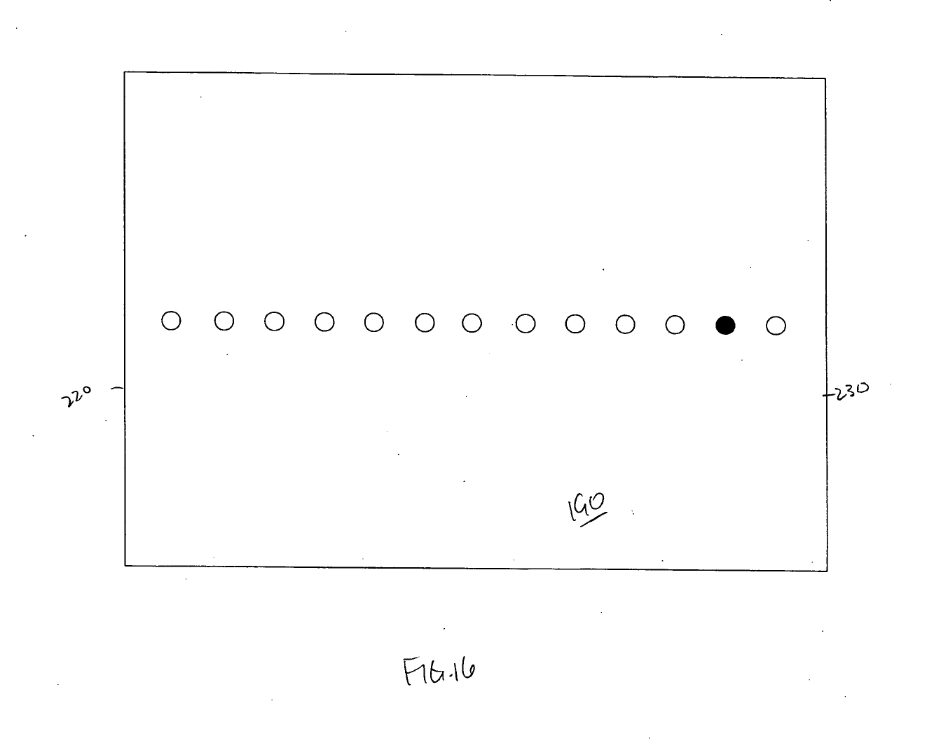

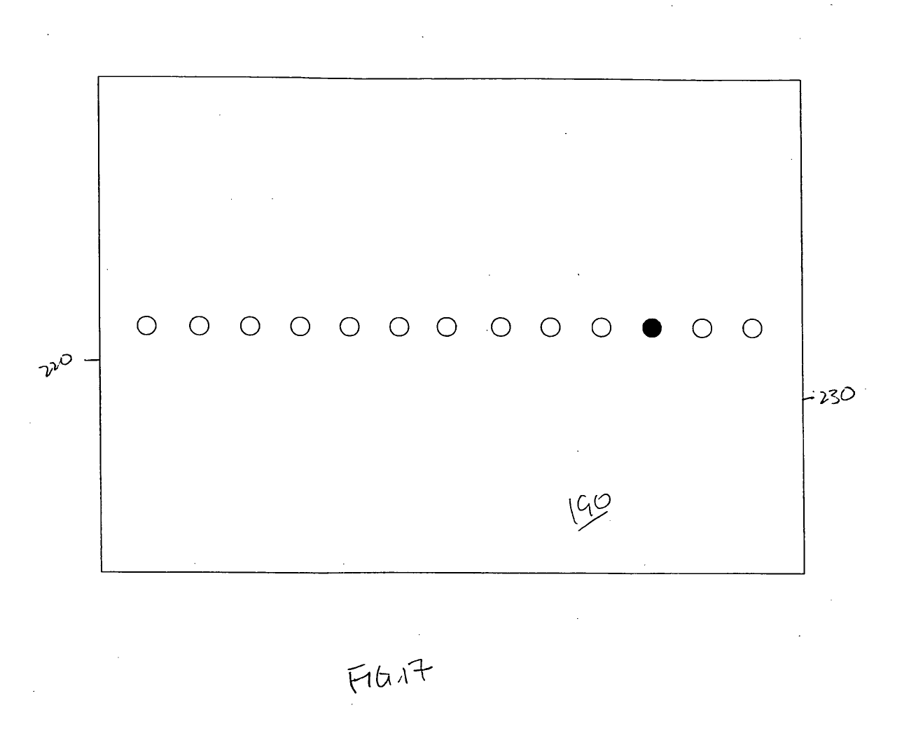

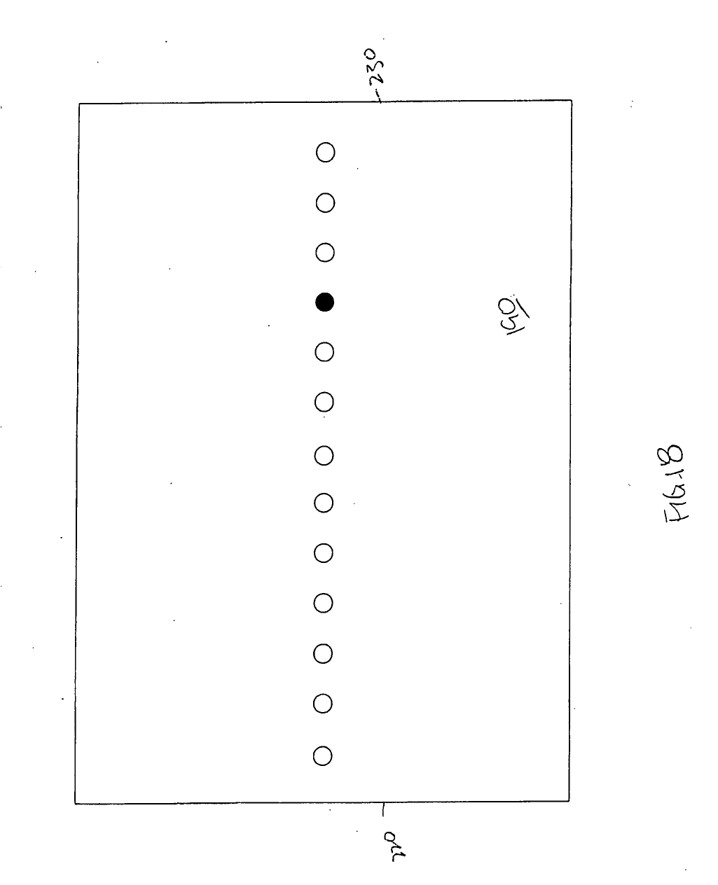

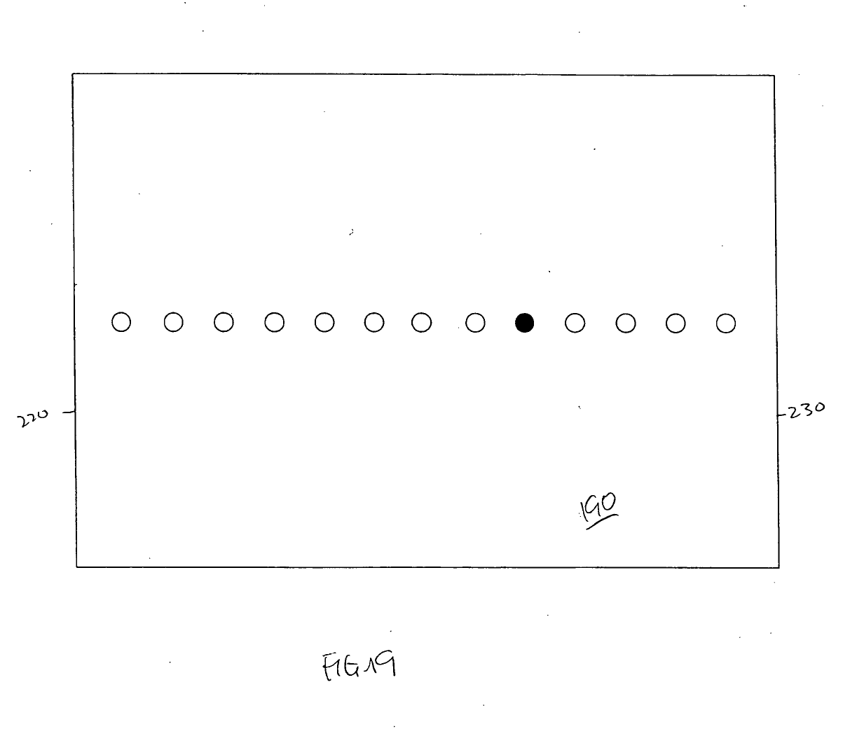

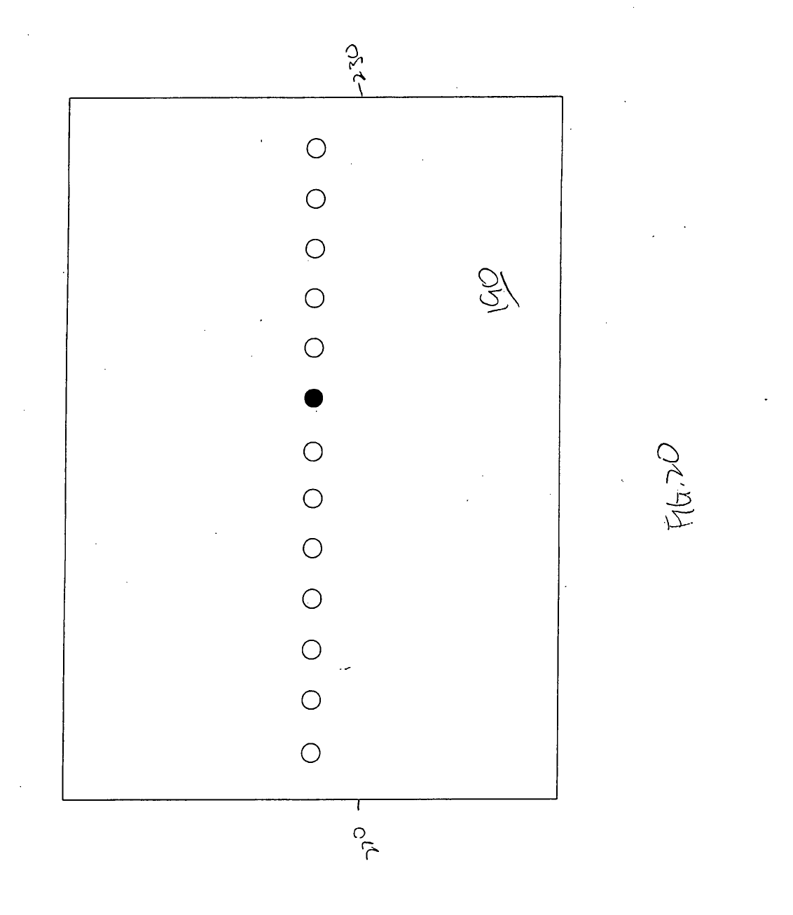

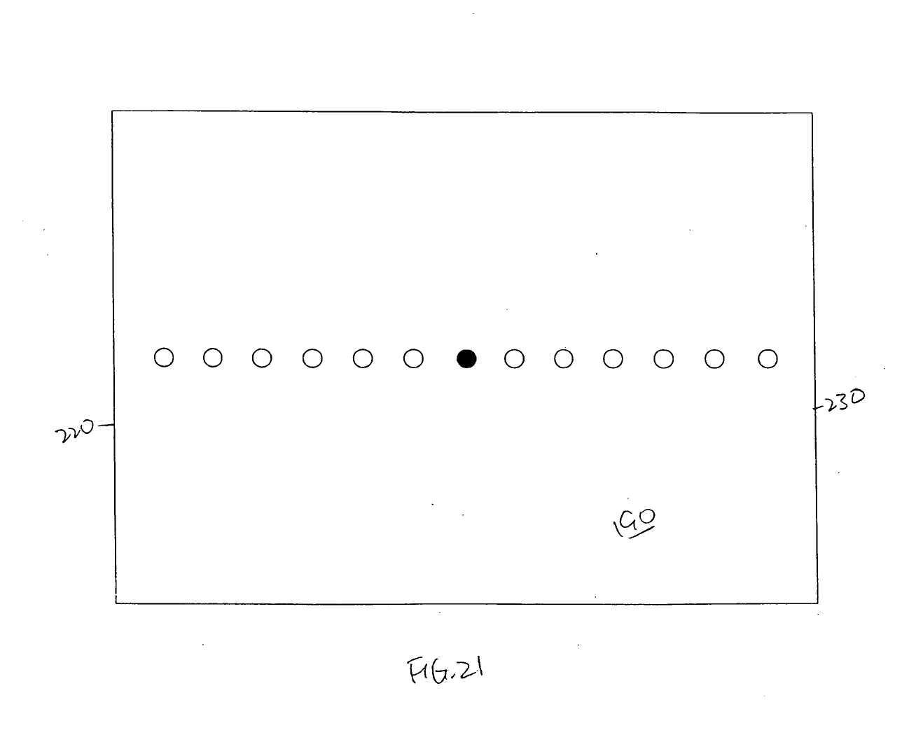

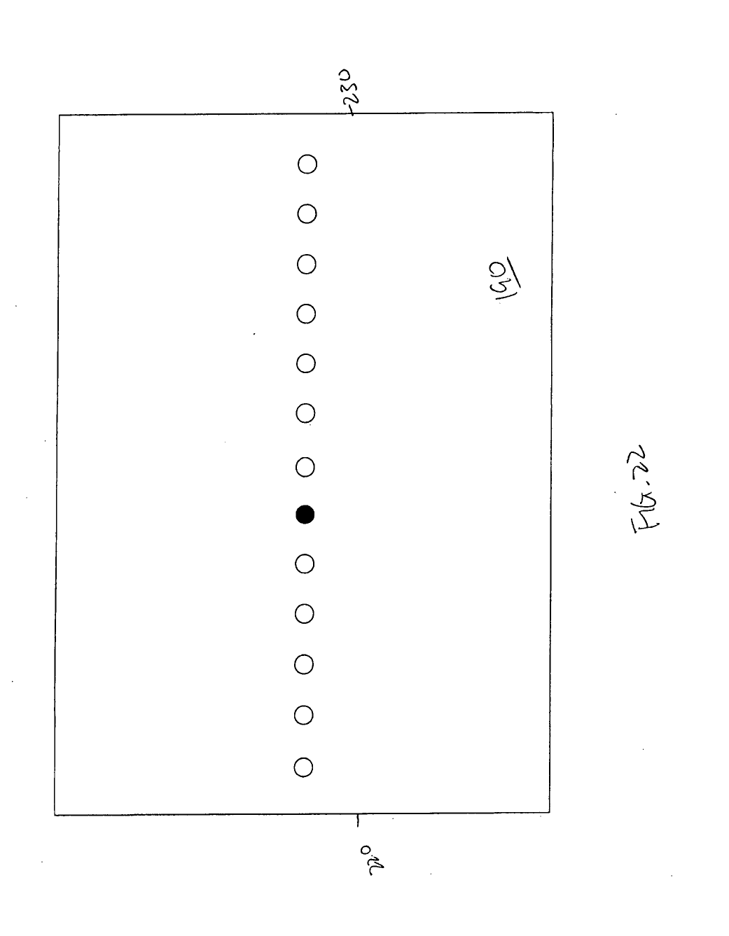

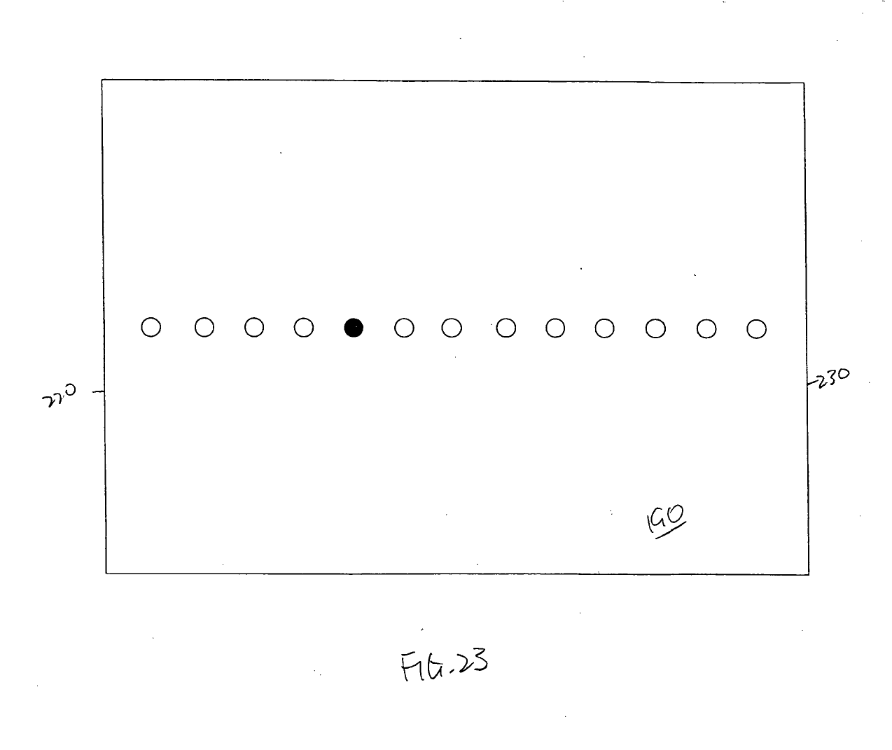

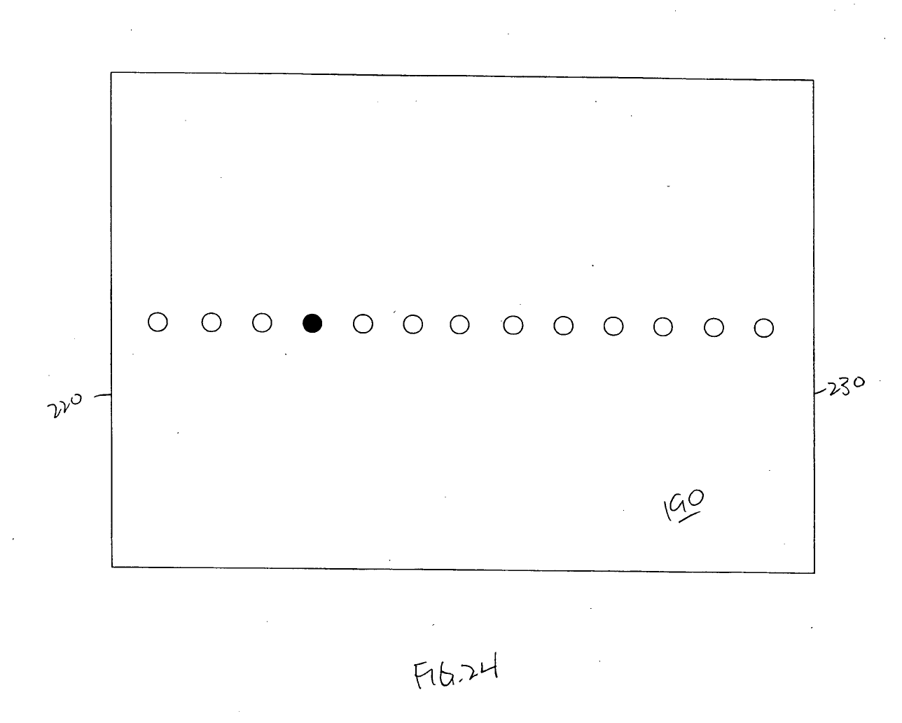

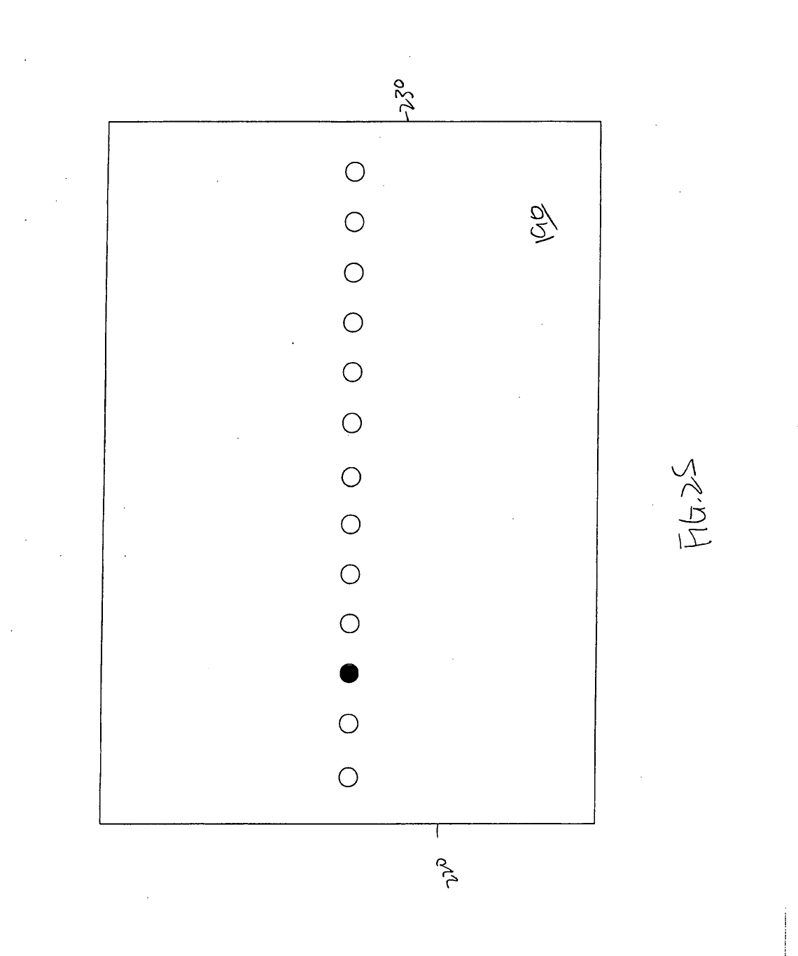

If a swimmer swims a two lap distance, Applicant's method causes the plurality of visible light emitting devices 160 to sequentially illuminate in a first sequence, and then to sequentially illuminate in a second and opposing sequence. For example and referring to FIGS. 1B, and 2 through 27, plurality of visible light emitting devices 160 is first caused to sequentially illuminate from device 162 through device 186 as the swimmer progresses from side 220 to side 230, and then is caused to sequentially illuminate from device 186 through device 162 as the swimmer progresses from side 230 to side 220. For a three lap distance, Applicant's method causes the plurality of visible light emitting devices 160 to sequentially illuminate in a first sequence, and then to sequentially illuminate in a second and opposing sequence, and then to sequentially illuminate in the first sequence.

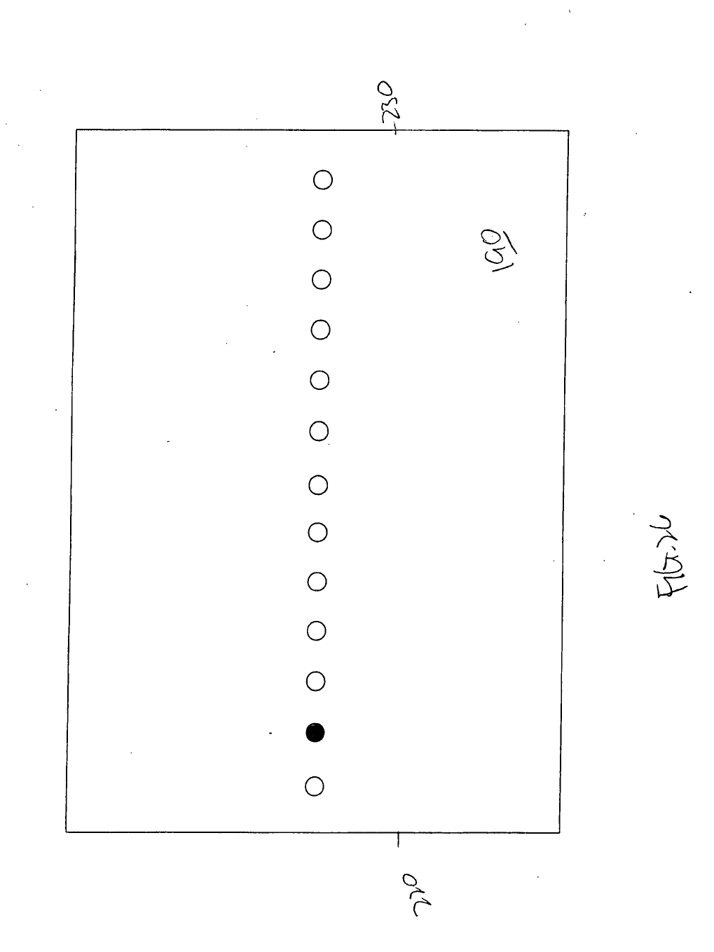

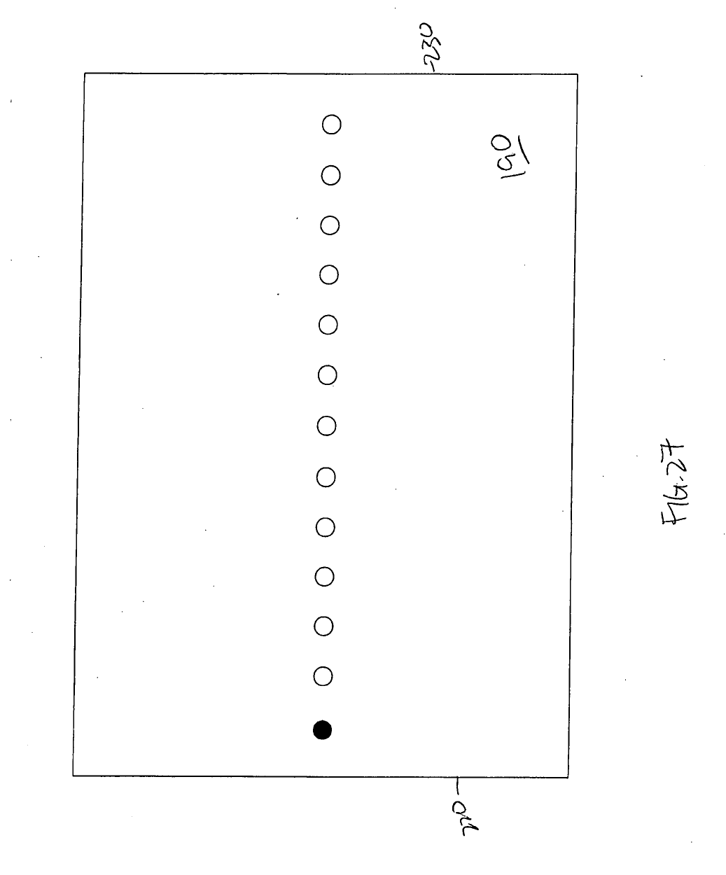

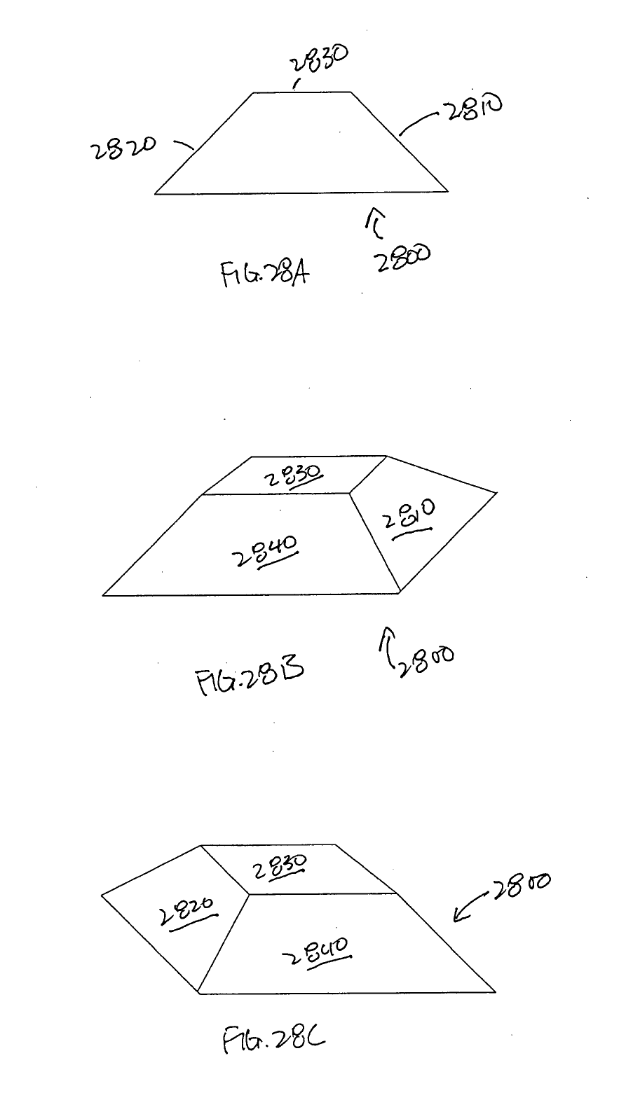

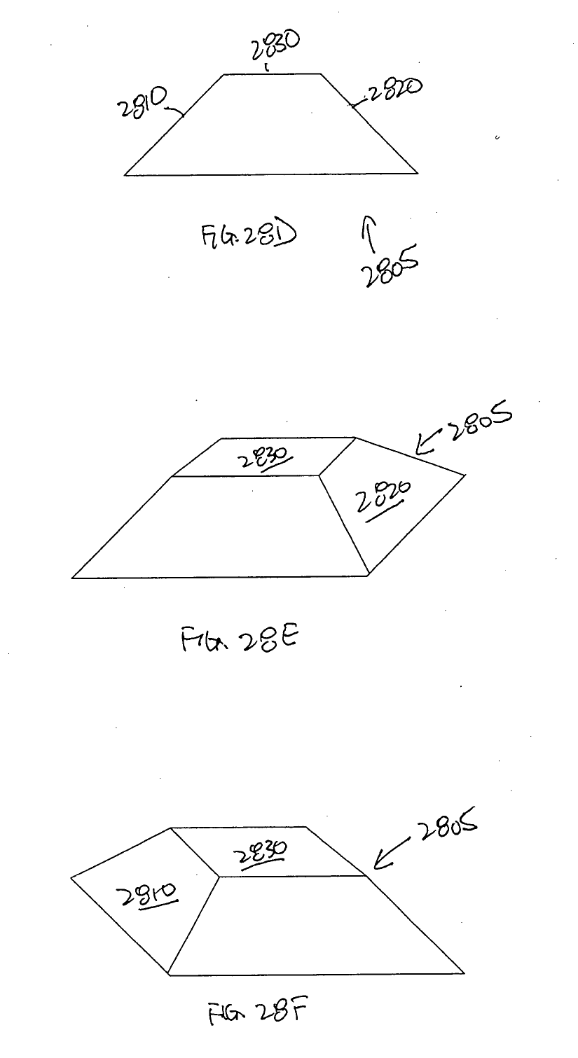

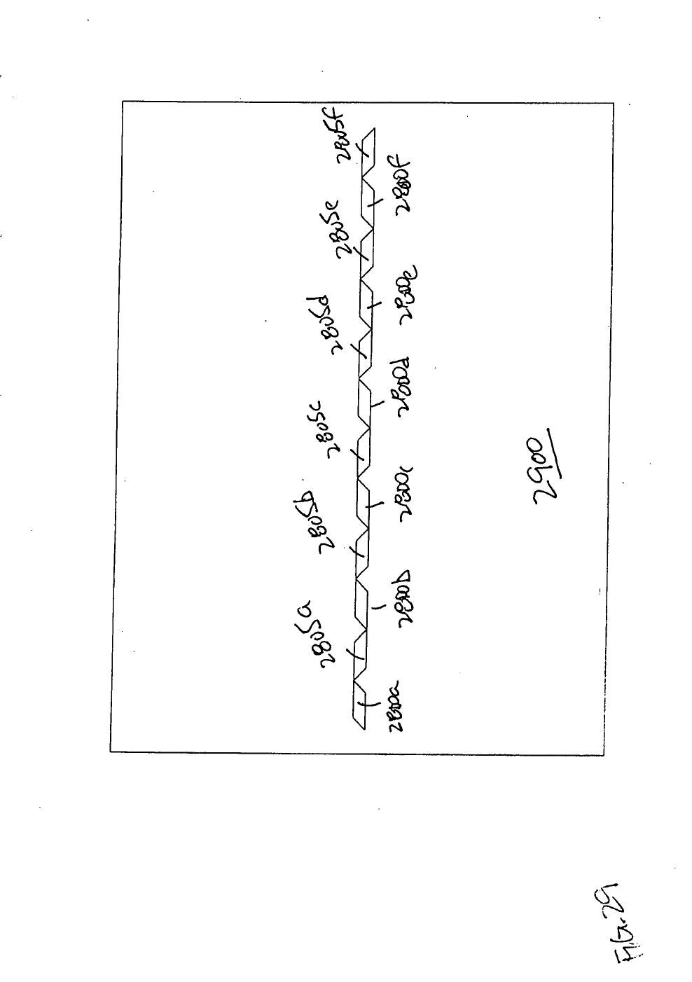

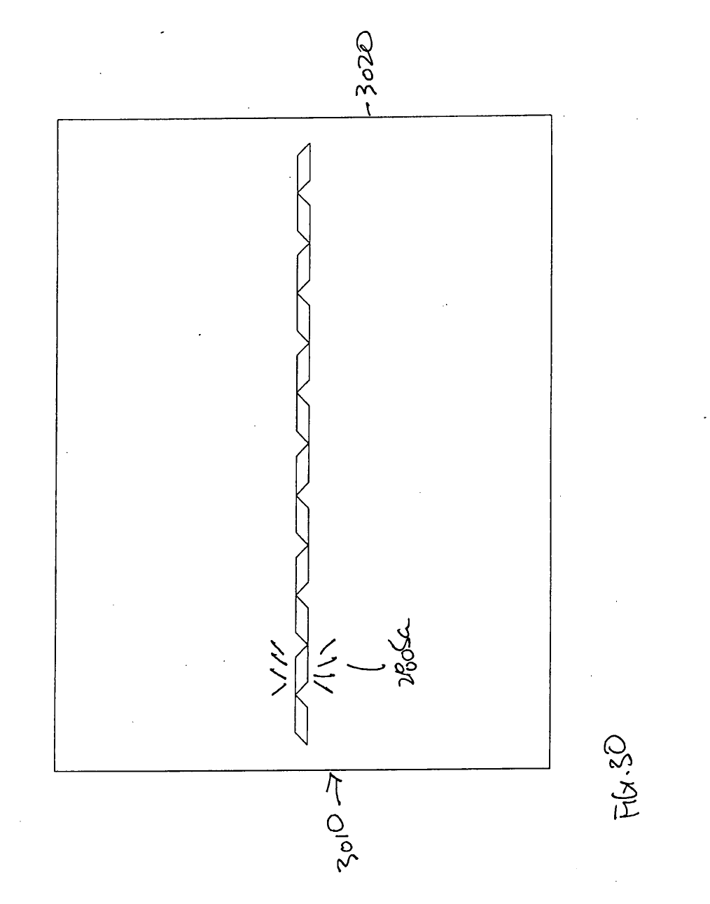

In certain embodiments Applicant's visible light emitting device comprises a plurality of lens, wherein each of the plurality of lenses comprises a different color. Referring now to FIGS. 28A, 28B, and 28C, visible light emitting device 2800 comprises lens 2810 disposed on a first side, lens 2820 disposed on a second and opposing side, and lens 2830 disposed on a top portion. In certain embodiments, lens 2810 comprises a green color, lens 2820 comprises a red color, and lens 2830 comprises a white color. In certain embodiments, sides 2840 disposed between colored lenses 2810 and 2820 are opaque, and therefore, do not emit light.

When the light emitting device 2800 is energized and emits light, if the swimmer sees a red color, then the swimmer is approaching device 2800 and is swimming behind the desired pace. On the other hand, if the swimmer sees a white color, then the swimmer is passing over device 2800 and is swimming at the desired pace. However, if the swimmer sees a green color, then the swimmer has passed device 2800 and is swimming ahead of the desired pace.

Referring to FIGS. 28D, 28E, and 28F, visible light emitting device 2805 comprises a plurality of lenses, wherein the positions of the red lens and the green lens is reversed with respect to device 2800.

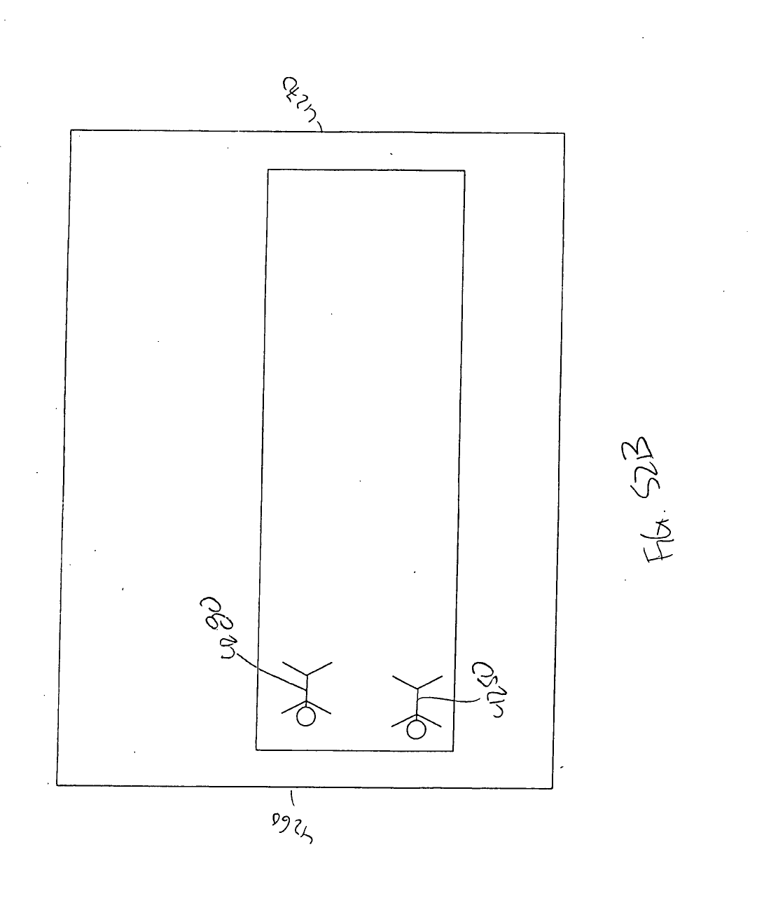

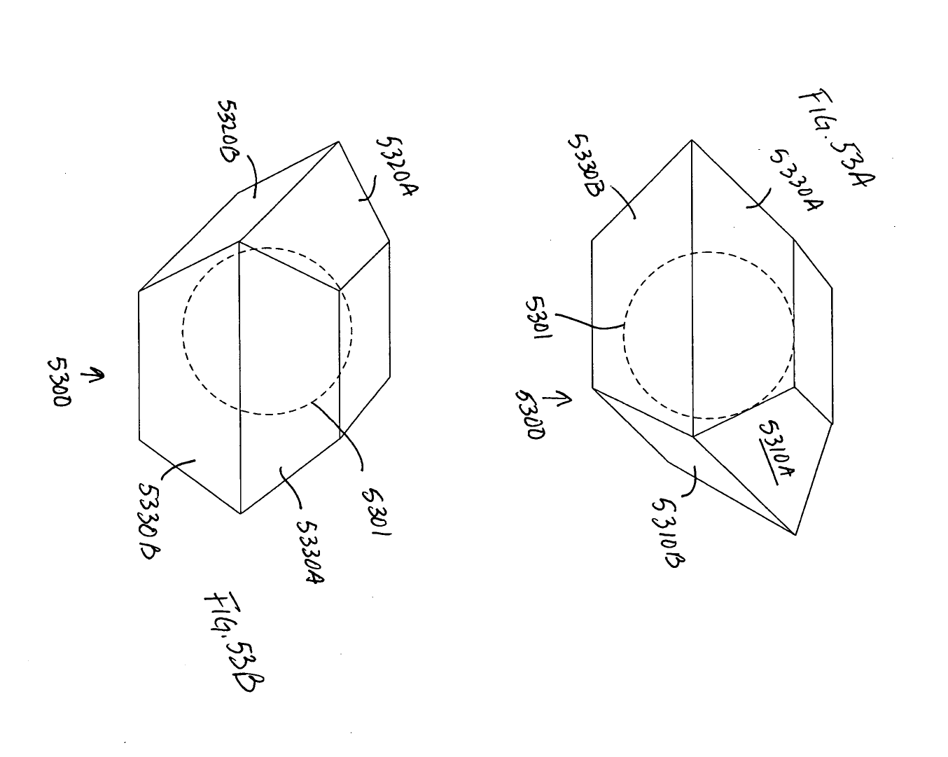

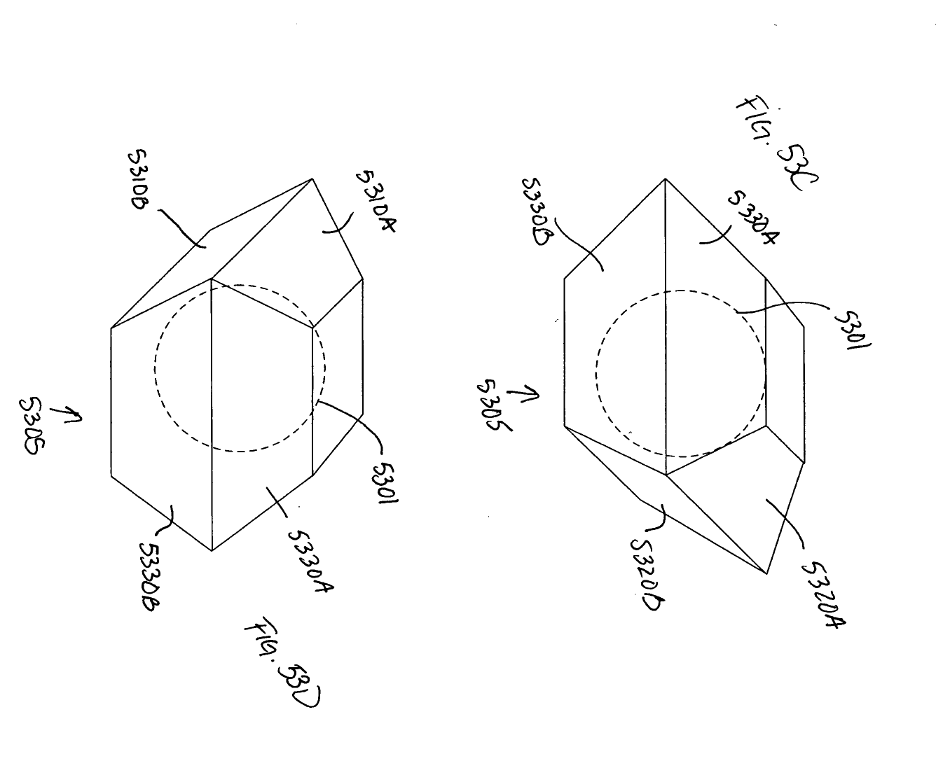

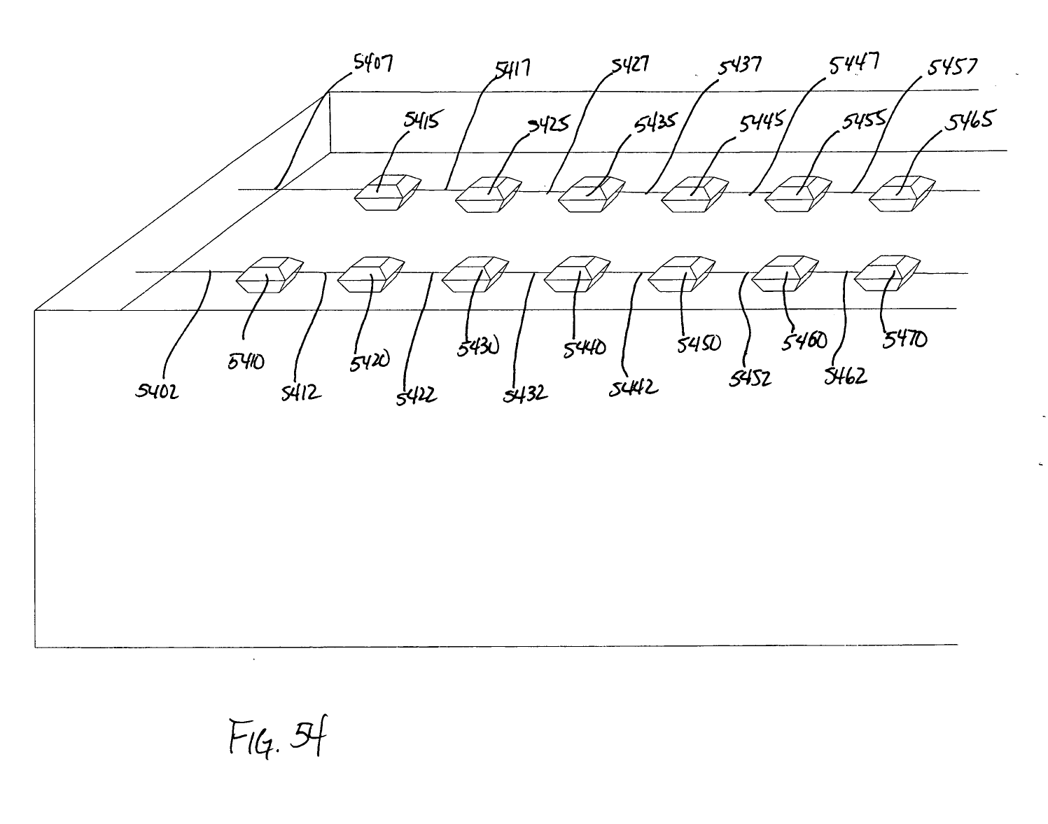

Referring now to FIGS. 53A and 53B, in certain embodiments Applicant's visible light emitting device is disposed in a water-tight enclosure that floats on the surface of the water, i.e. in a buoy. Referring now to FIG. 53A, buoy 5300 comprises a water-tight enclosure 5301 comprising a plurality of lens, wherein each of the plurality of lenses comprises a different color. Buoy 5300 comprises lenses 5310A and 5310B disposed on a first side, lenses 5320A and 5320B disposed on a second and opposing side, and lenses 5330A and 5330B disposed between lenses 5310A/B and 5320A/B. In certain embodiments, lenses 5310A and 5310B comprises a green color, lens 5320A and 5320B comprise a red color, and lenses 5330A and 5330B comprises a white color.

When light emitting device 5301 disposed in buoy 5300 is energized and emits light, if the swimmer sees a red color, then the swimmer is approaching buoy 5300 and is swimming behind the desired pace. On the other hand, if the swimmer sees a white color, then the swimmer is passing by buoy 5300 and is swimming at the desired pace. However, if the swimmer sees a green color, then the swimmer has passed buoy 5300 and is swimming ahead of the desired pace.

Referring to FIGS. 53C and 53D, buoy 5305 comprises a plurality of lenses, wherein the positions of the red lenses and the green lenses is reversed with respect to lenses 5330A and 5330B.

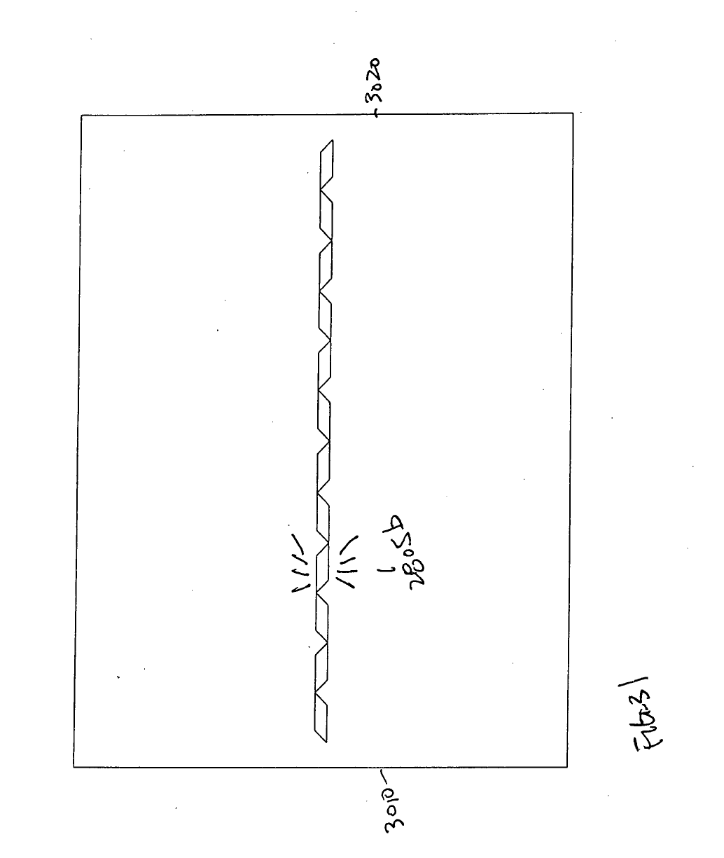

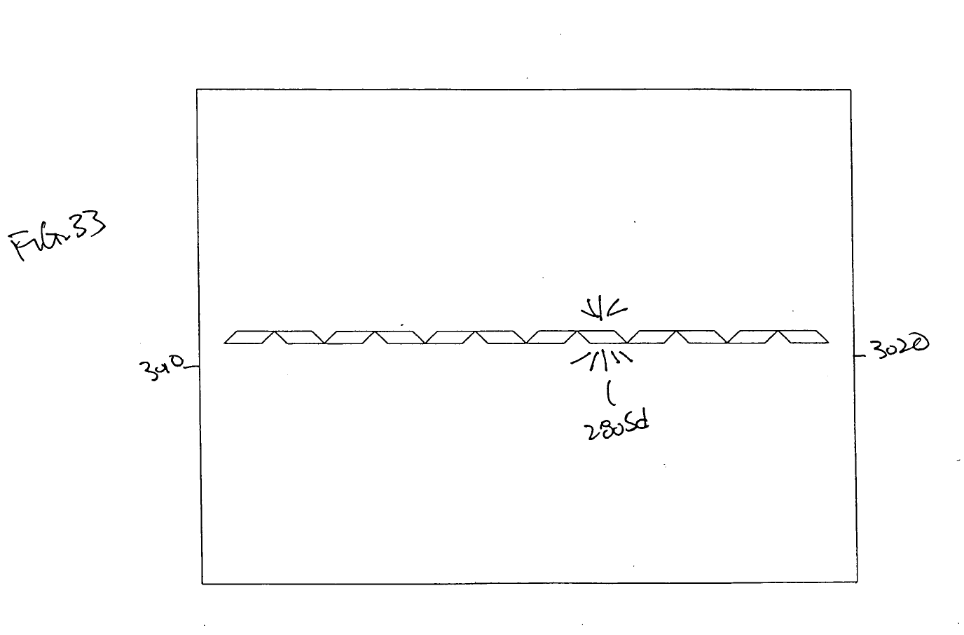

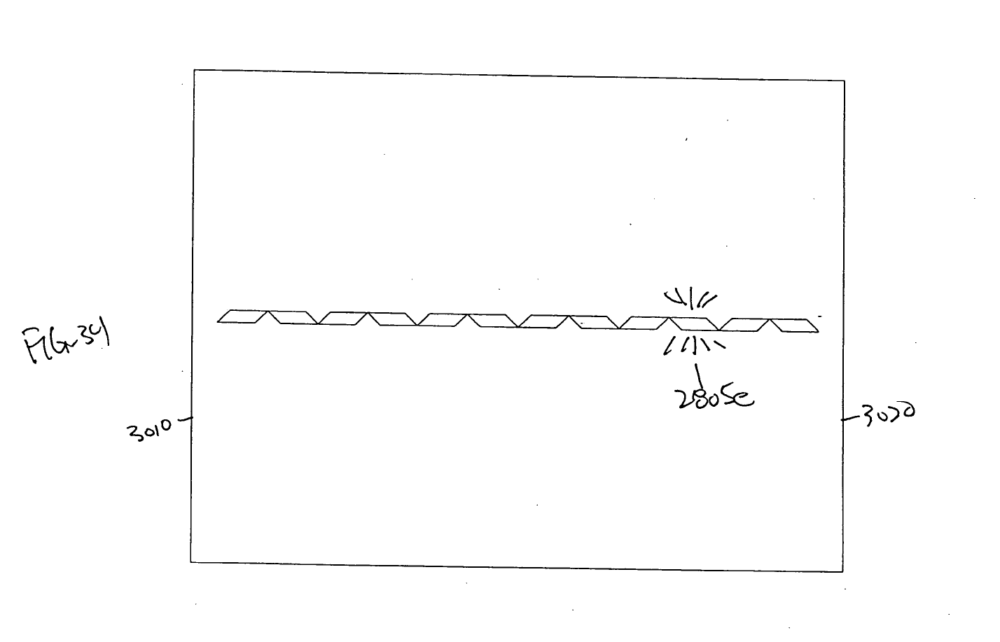

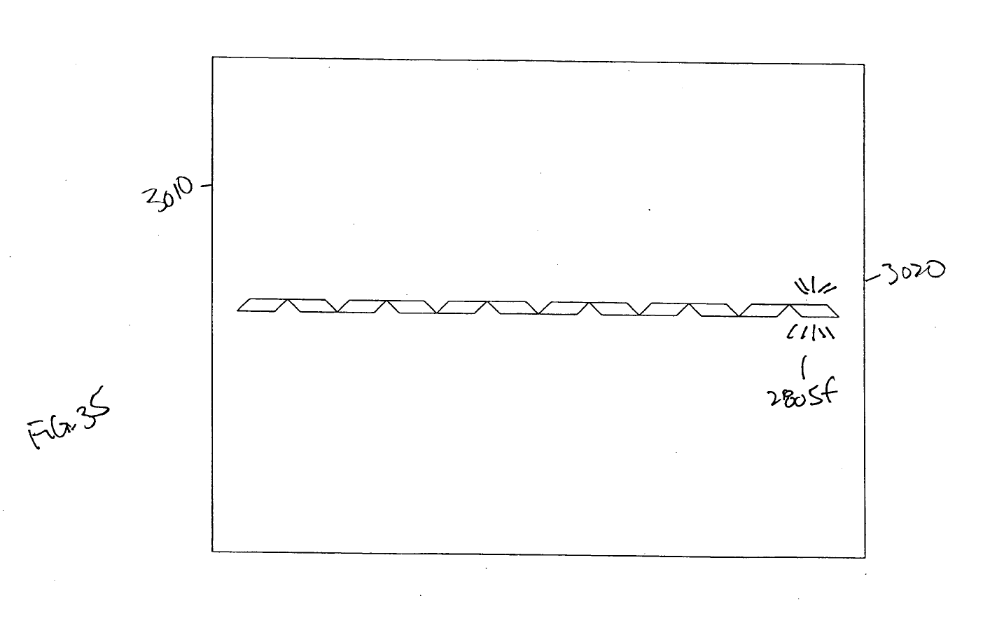

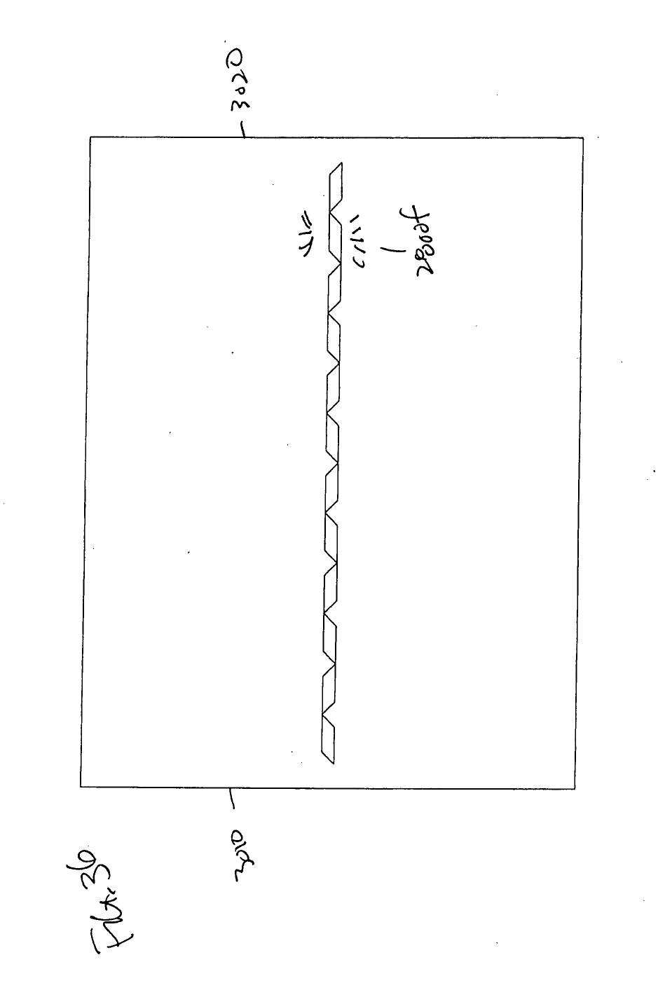

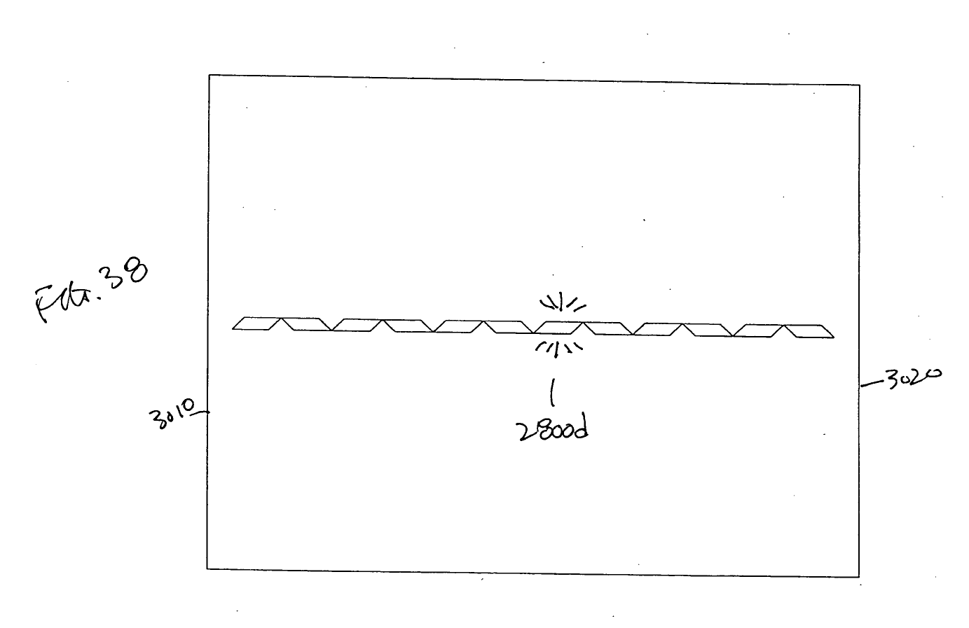

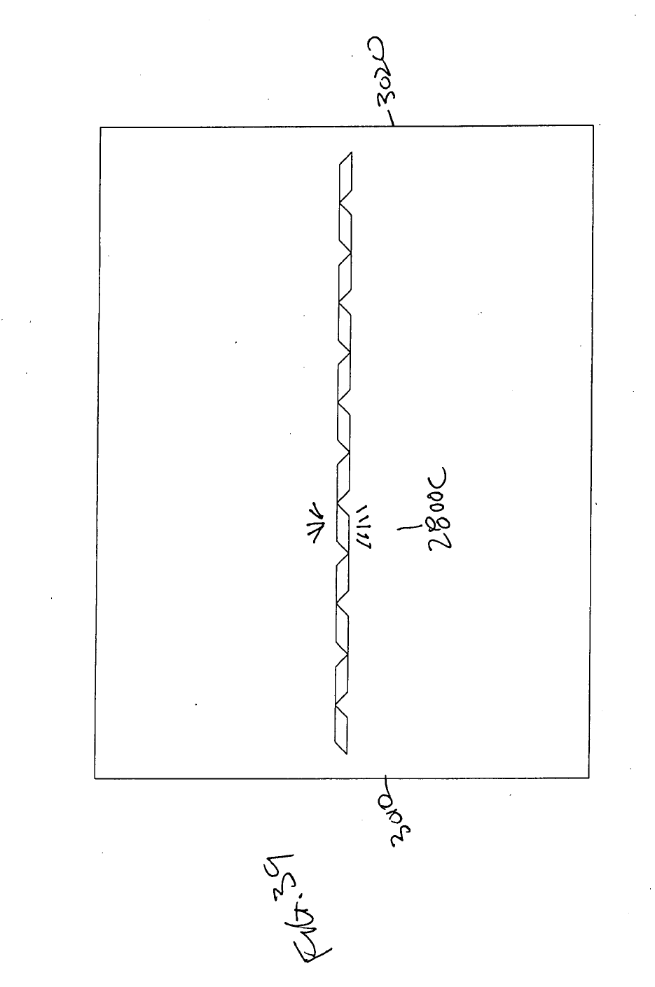

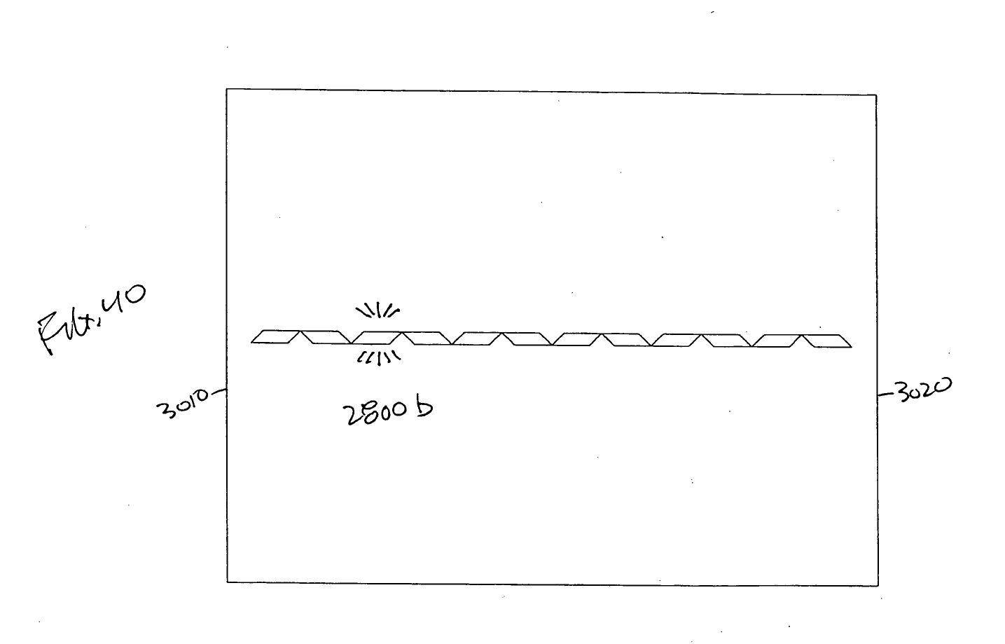

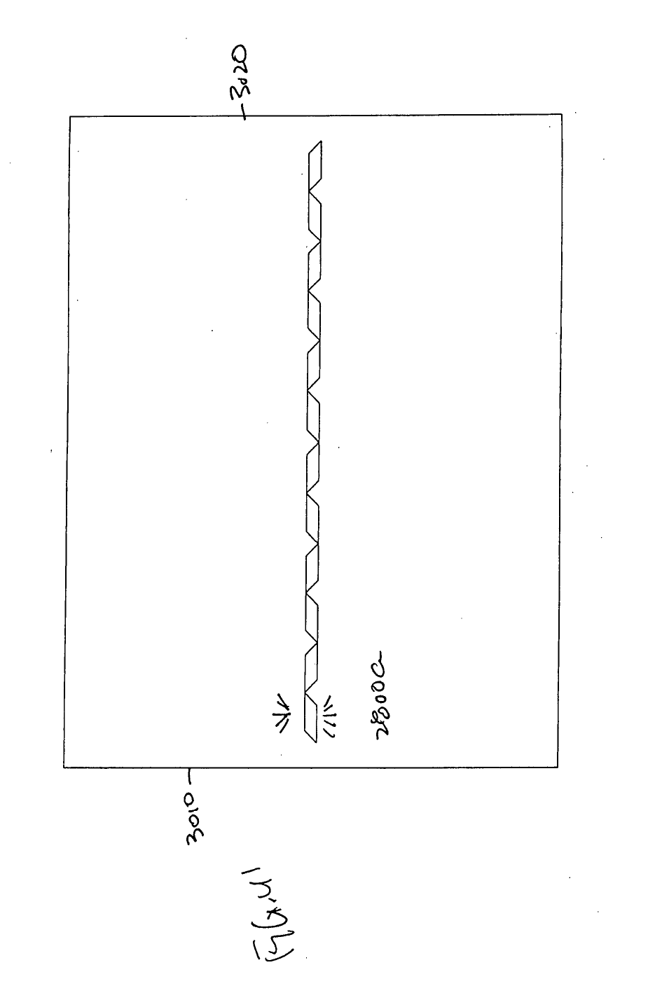

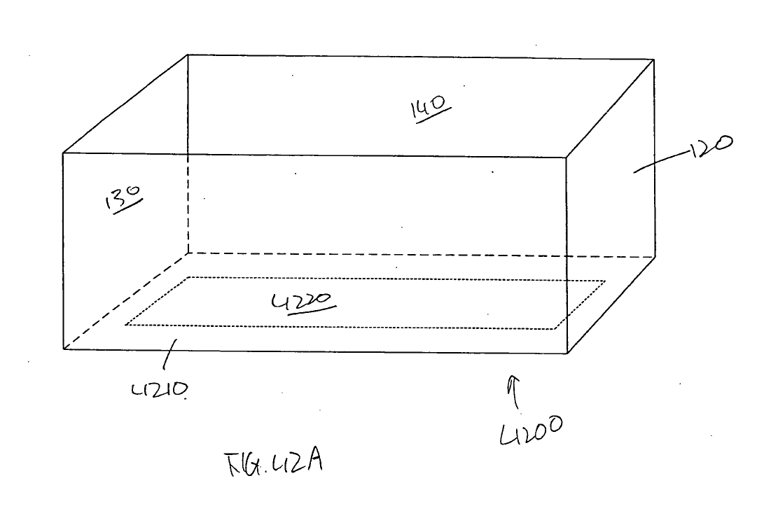

Referring now to FIG. 29, pool surface 2900 comprises a plurality of visible light emitting devices 2800 in combination with a plurality of visible light emitting devices 2805. In certain embodiments, pool surface 2900 comprises pool bottom 110 (FIG. 1). In certain embodiments, pool surface 2900 comprises pool side 140 and/or 150 (FIG. 1). For the sake of clarity, FIGS. 29 through 41 show one linear pattern of alternating devices 2800 and 2805. As those skilled in the art will appreciate, such a linear pattern of alternating devices 2800/2805 can be disposed in one or more of (N) swimming lanes in a pool, wherein (N) is greater than or equal to 1.

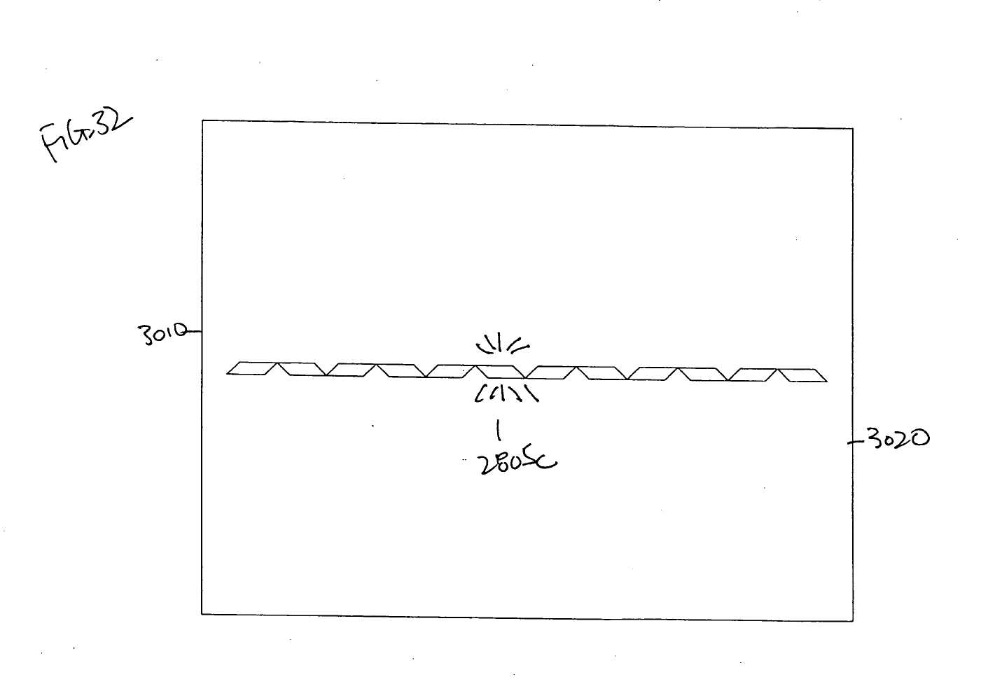

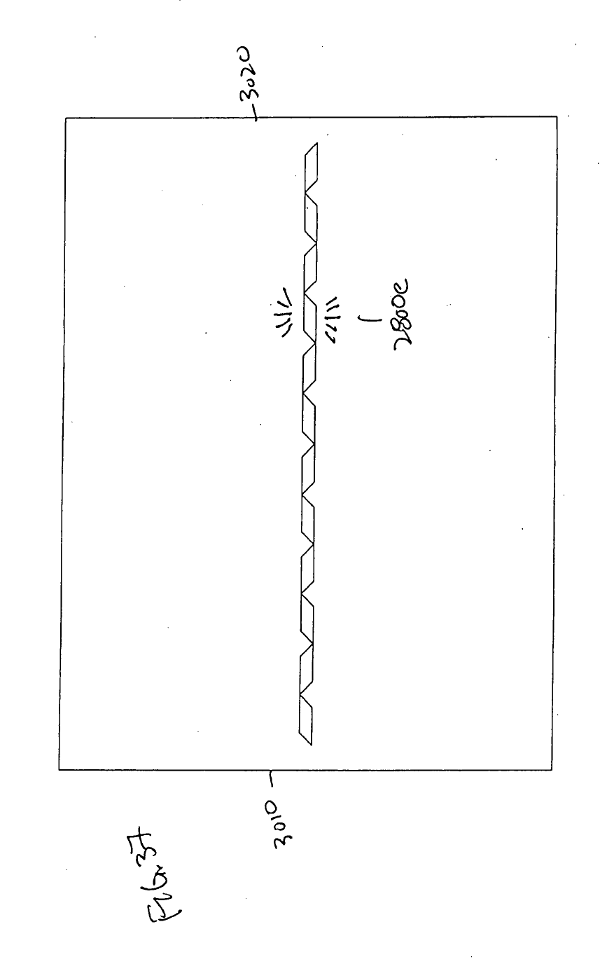

Referring now to FIGS. 30 through 35, as the swimmer swims in a first direction across Applicant's pool from side 3010 to side 3020, the plurality of visible light emitting devices 2805a through 2805f are caused to sequentially illuminate according to a pre-determined sequence. Referring now to FIGS. 36 through 41, as the swimmer swims in a second direction across Applicant's pool from side 3020 to side 3010, the plurality of visible light emitting devices 2800f through 2800a are caused to sequentially illuminate according to a pre-determined sequence.

FIG. 54 illustrates a plurality of buoys 5400, namely buoys 5410, 5420, 5430, 5440, 5450, 5460, and 5470, interconnected and floating on the surface of water in pool 540. Tether line 5402 comprises a communication and power link and interconnect buoy 5410 and the pool wall. Similarly, tether lines 5412, 5422, 5432, 5442, 5452, and 5462, comprises a communication and power link and interconnect buoy 5410 and 5420, 5420 and 5430, 5430 and 5440, 5440 and 5450, 5450 and 5460, and 5460 and 5470, respectively. Applicant's method provides electrical signals to buoys 5410, 5420, 5430, 5440, 5450, 5460, and 5470, using this plurality of tether lines, such that Applicant's method can selectively cause each of those buoys to individually energize and emit visible light in a programmed fashion.

FIG. 54 further illustrates shows a plurality of buoys 5405, namely buoys 5415, 5425, 5435, 5445, 5455, 5465, and 5475, interconnected and floating on the surface of water in pool 540. Tether line 5407 comprises a communication and power link and interconnect buoy 5415 and the pool wall. Similarly, tether lines 5417, 5427, 5437, 5447, 5457, and 5467, comprises a communication and power link and interconnect buoys 5415 and 5425, 5425 and 5435, 5435 and 5445, 5445 and 5455, 5455 and 5465, respectively. Applicant's method provides electrical signals to buoys 5415, 5425, 5435, 5445, 5455, and 5465, using this plurality of tether lines, such that Applicant's method can selectively cause each of those buoys to individually energize and emit visible light in a programmed fashion.

When a swimmer swims in a first direction in the lane defined by the plurality of buoys 5400 and the plurality of buoys 5405, Applicant's method sequentially energizes, in a programmed fashion, the light emitting devices disposed in successive buoys in either the plurality of buoys 5400 or 5405 but not in both. When the swimmer reaches the opposite side of the pool and reverses course, Applicant's method then sequentially energizes, in a programmed fashion, the other plurality of buoys.

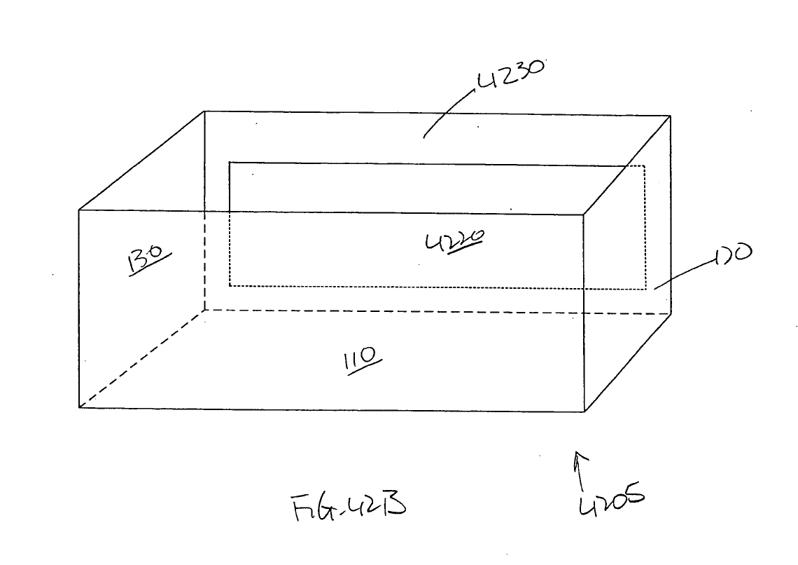

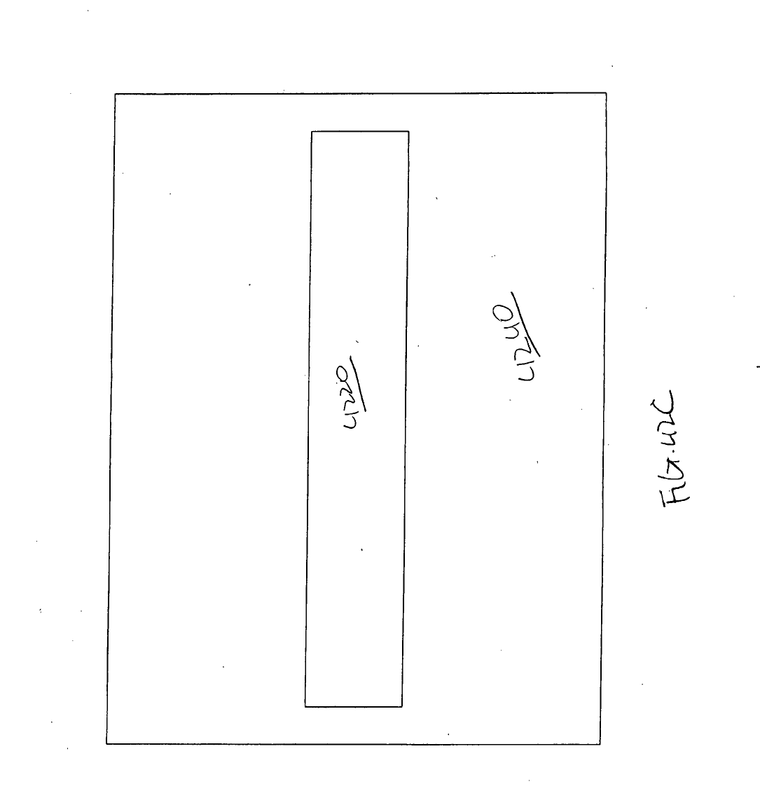

In the illustrated embodiment of FIG. 42A, Applicant's pool 4200 comprises sides 120 (FIG. 1A), 130 (FIG. 1A), 140 (FIG. 1A), and 150 (FIG. 1A), in combination with bottom 4210. Visual display device 4220 is disposed on bottom 4210. In certain embodiments, display 4220 comprises an integral unit which comprises a plurality of visible light emitting devices, such as those taught by Ruthenberg et al. and/or Taylor et al. FIG. 42B shows visual display device 4220 disposed on side portion 4230. In certain embodiments, a display 4220 is disposed on one or more pool sides in combination with the bottom.

FIG. 42C shows pool surface 4240 wherein visual display device 4220 is disposed on pool surface 4240. In certain embodiments, pool surface 4240 comprises bottom 4210. In certain embodiments, pool surface 4240 comprises side 4230.

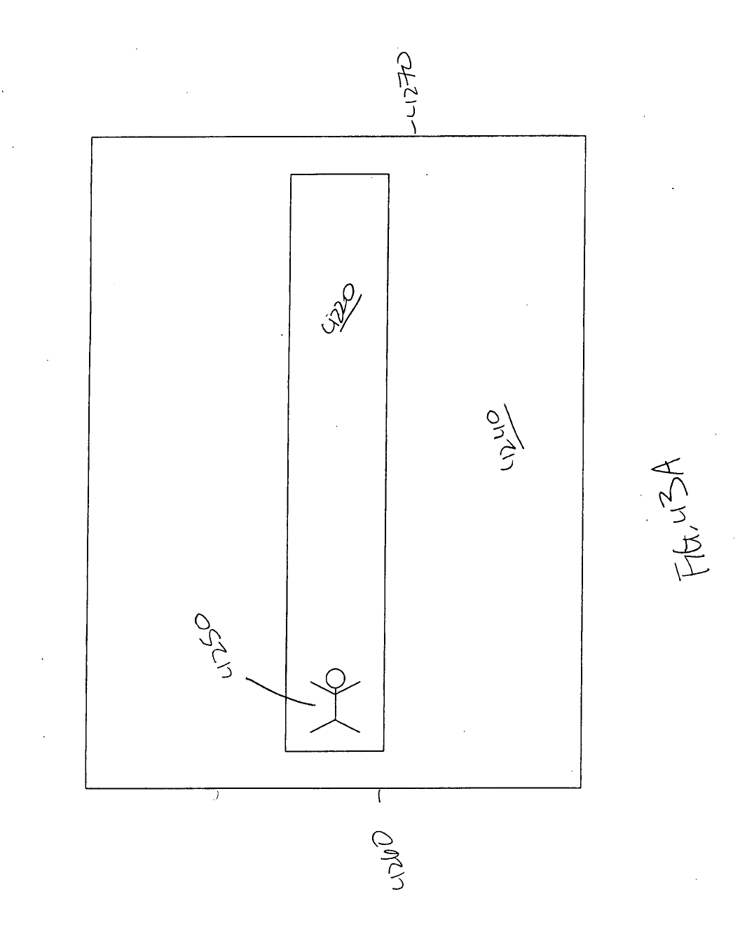

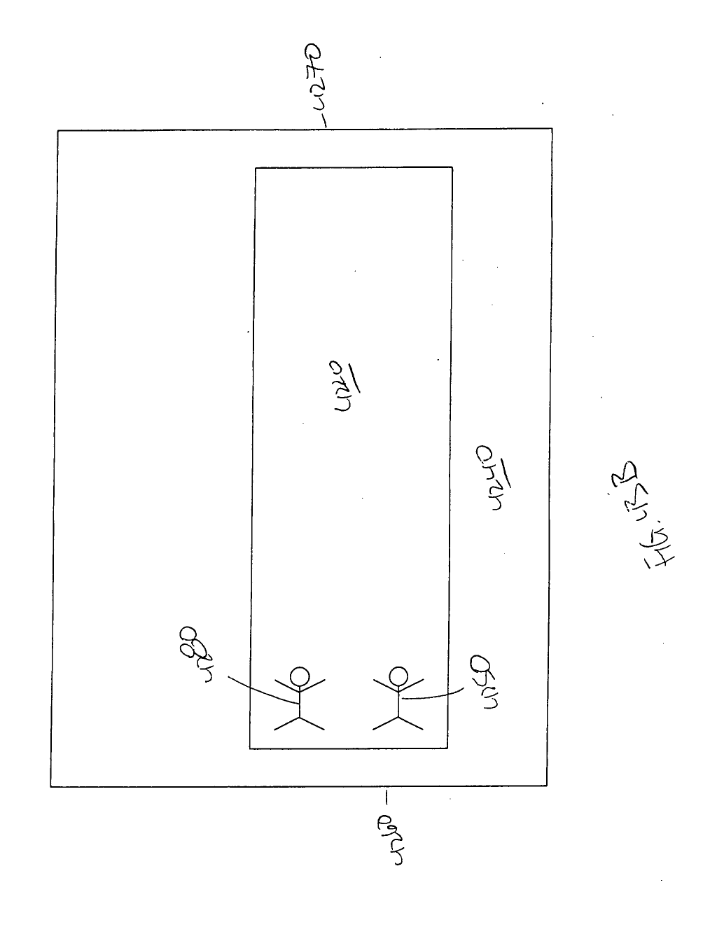

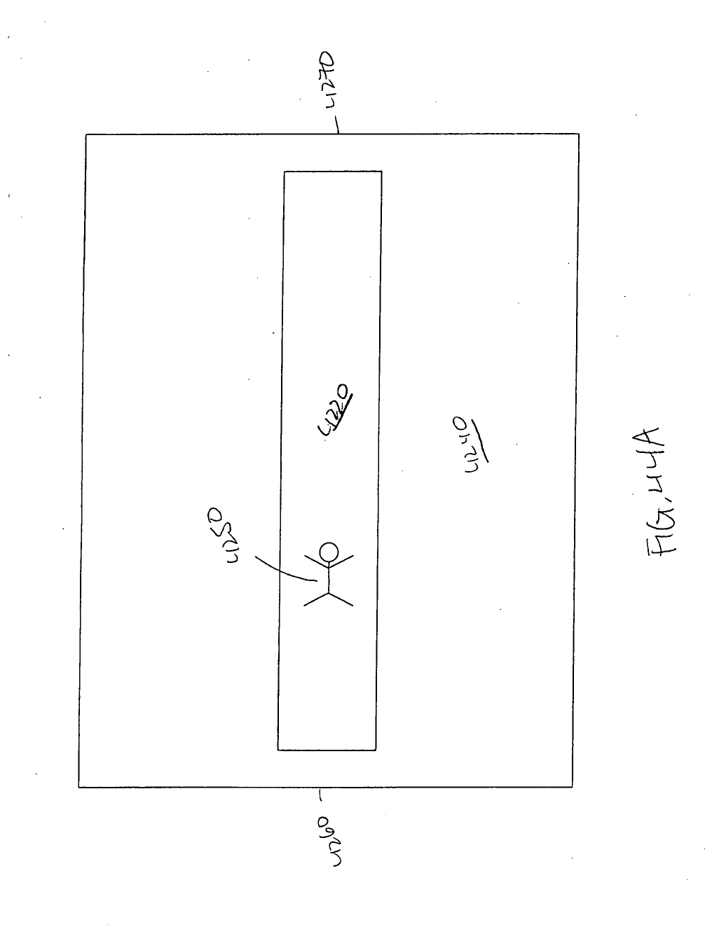

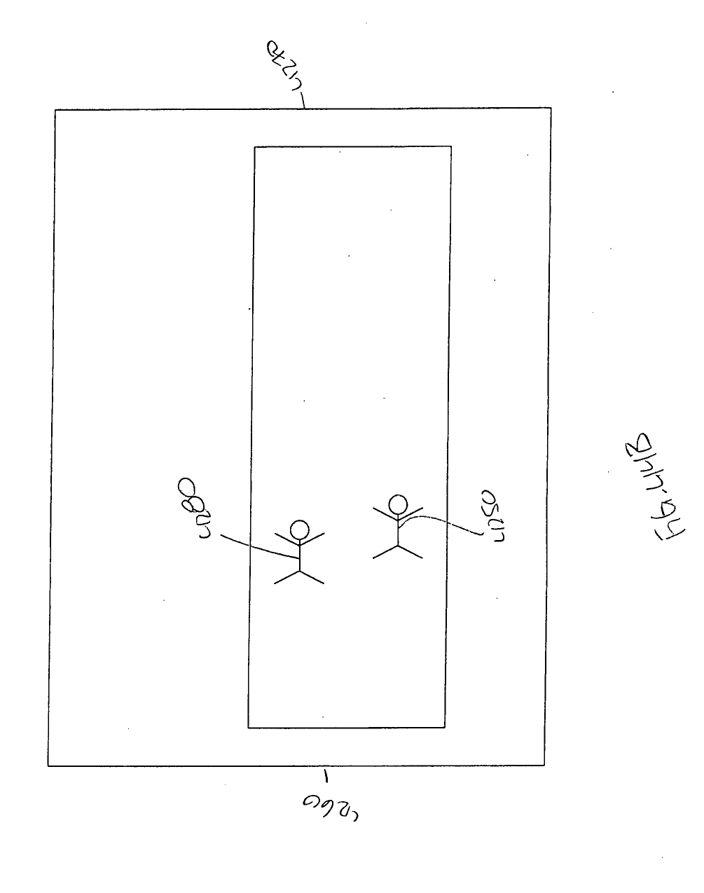

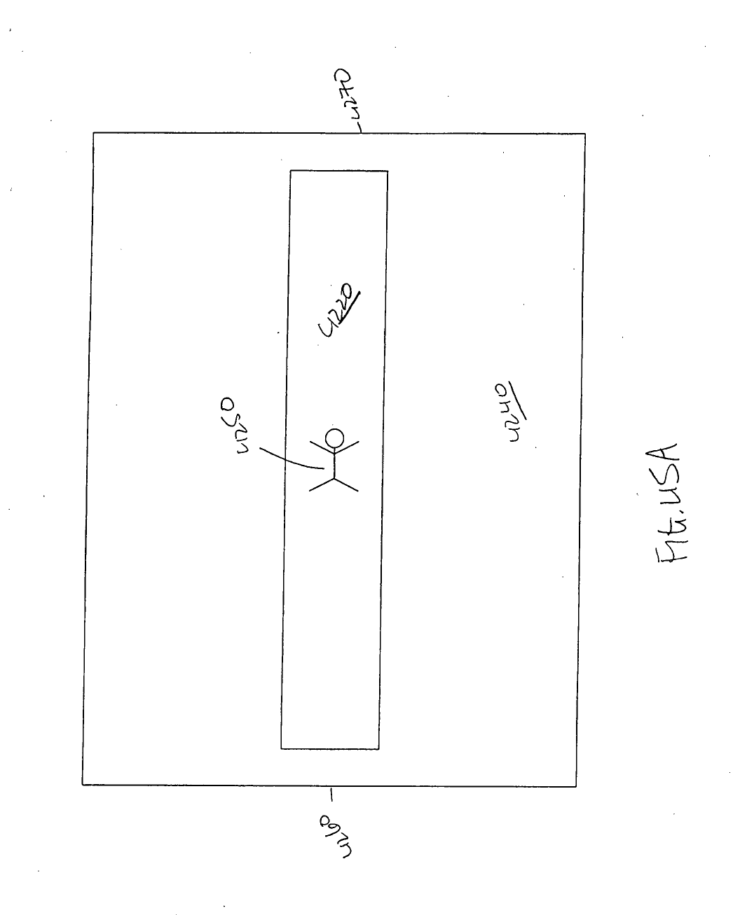

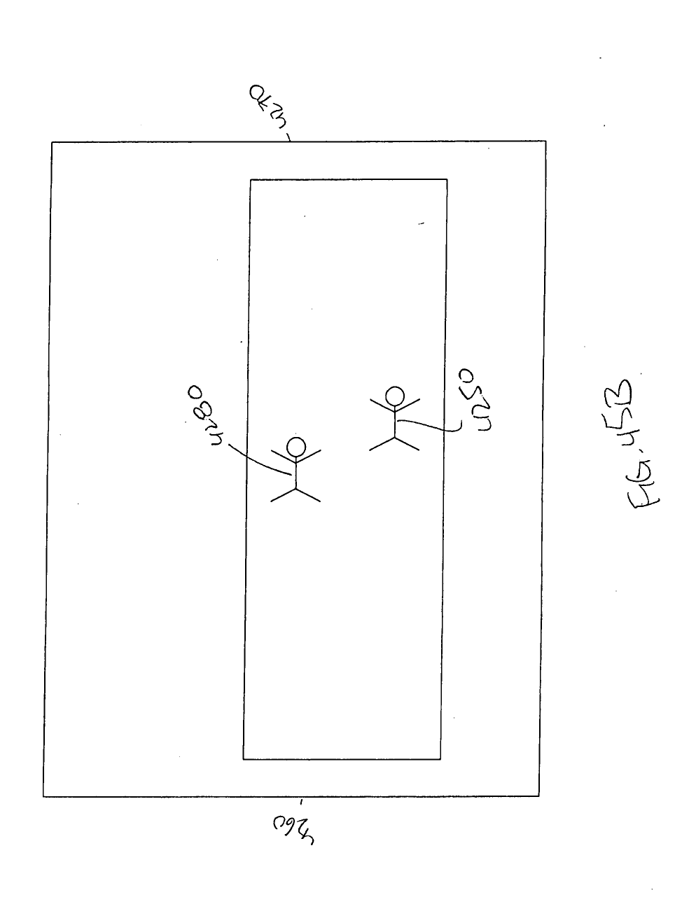

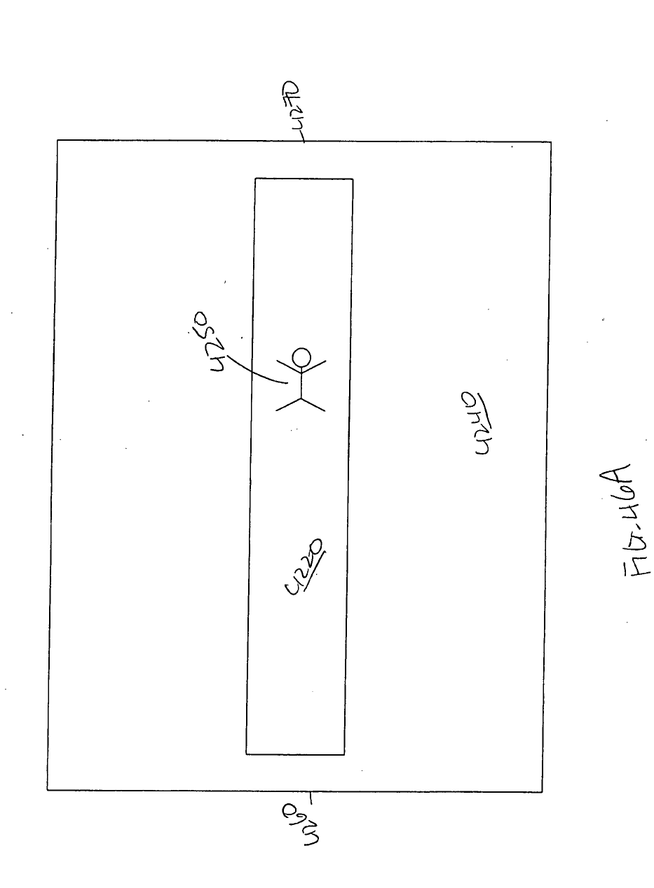

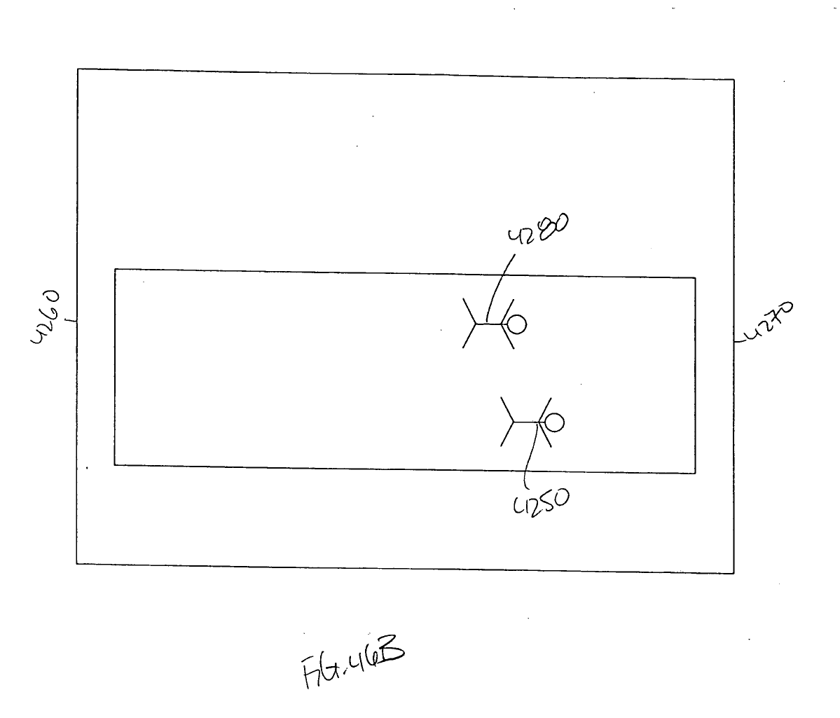

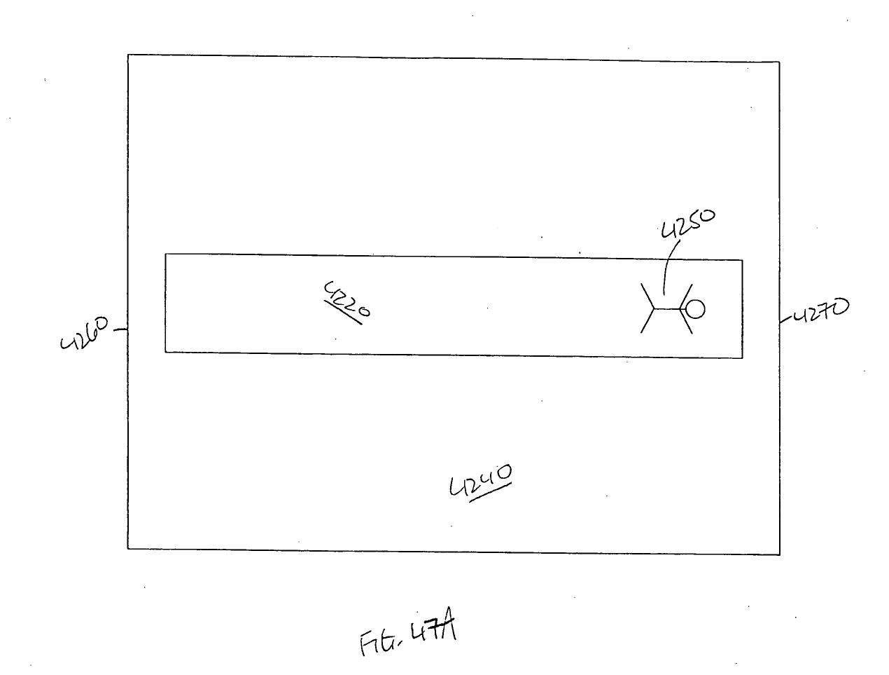

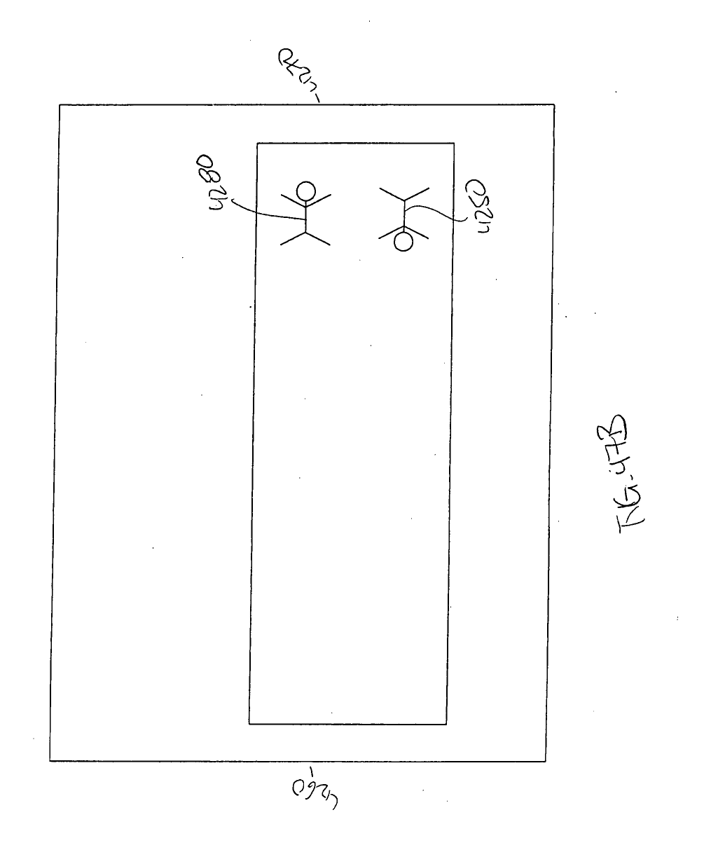

The illustrated embodiments of FIGS. 43A through 47A show visual rendition 4250 displayed on visual display device 4220 disposed on pool surface 4240. In certain embodiments, surface 4240 comprises a pool wall. In other embodiments, surface 4240 comprises the pool bottom. Visual rendition 4250 proceeds from side 4260 to side 4270. Rendition 4250 displays a calculated position based upon a desired swimming rate. The swimmer attempts to swim at the same rate as rendition 4250.

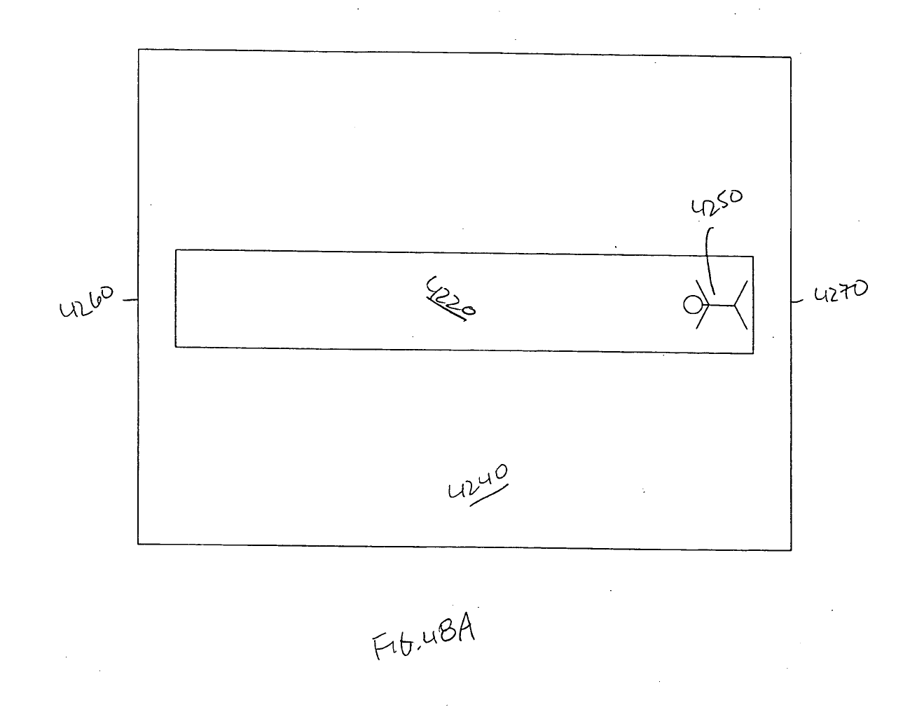

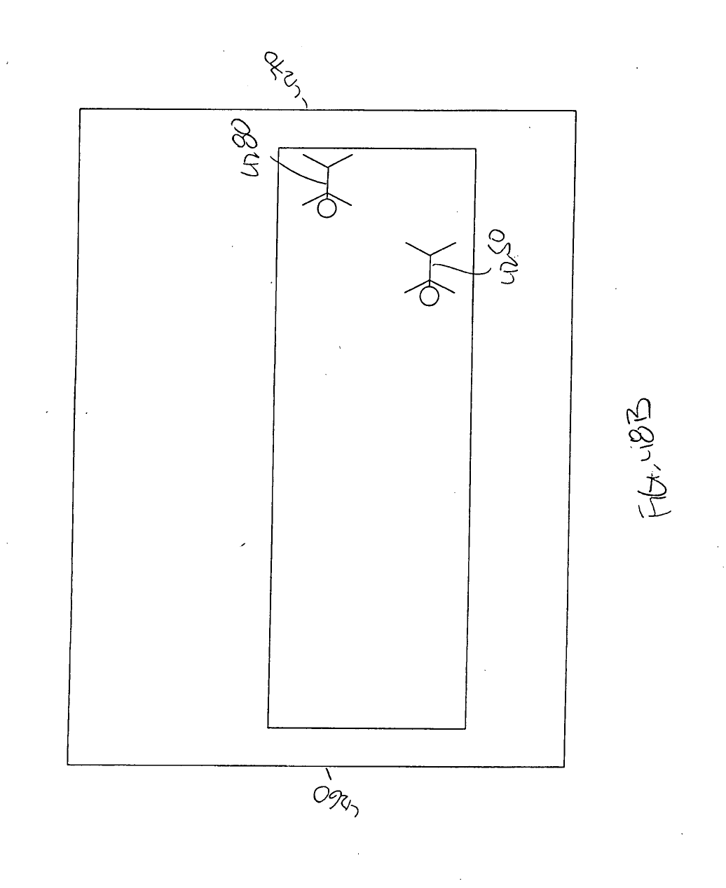

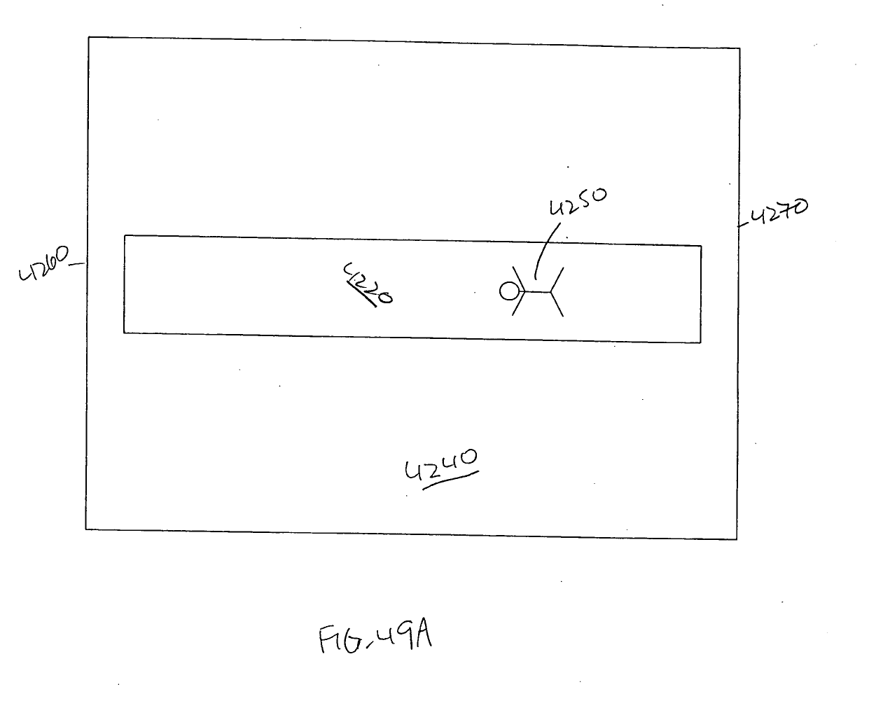

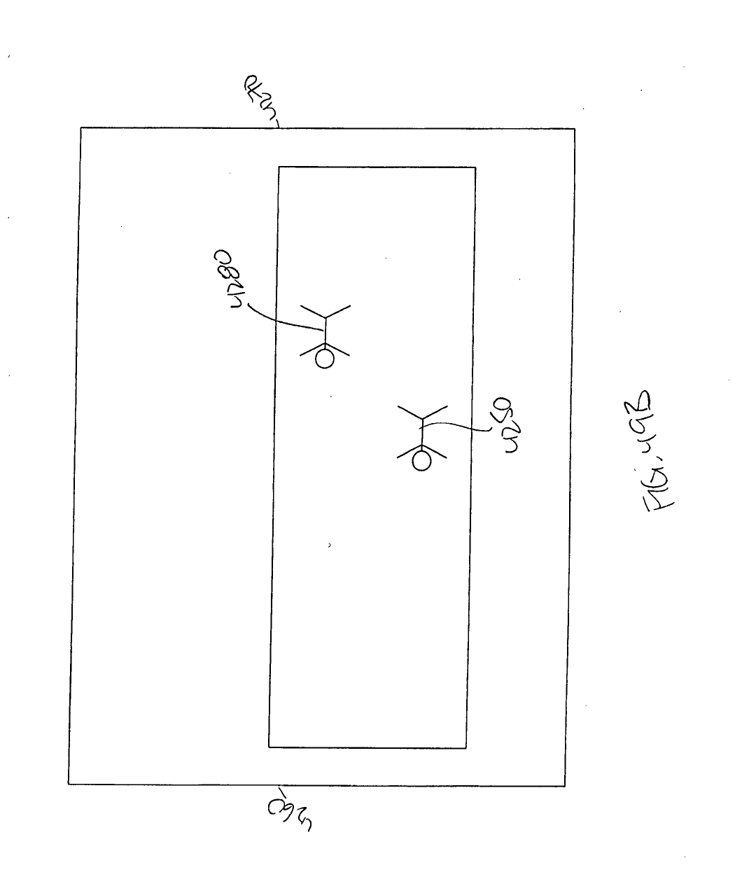

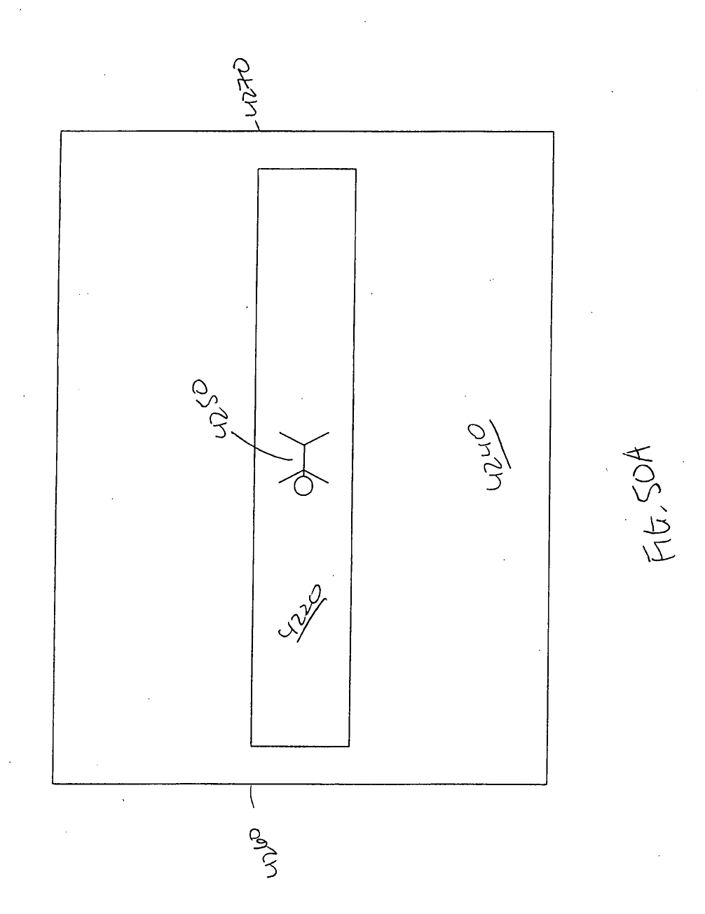

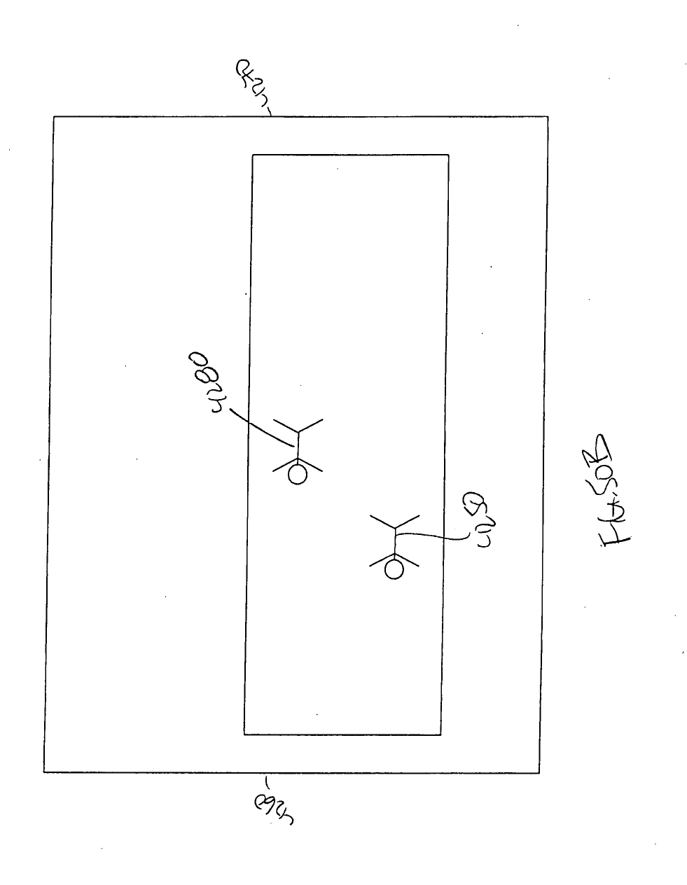

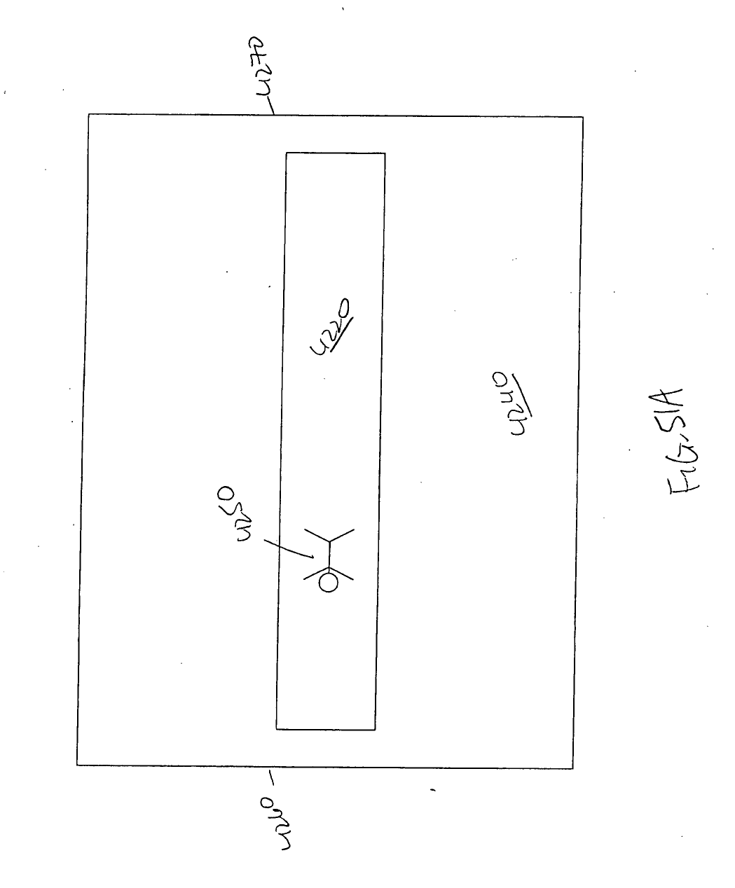

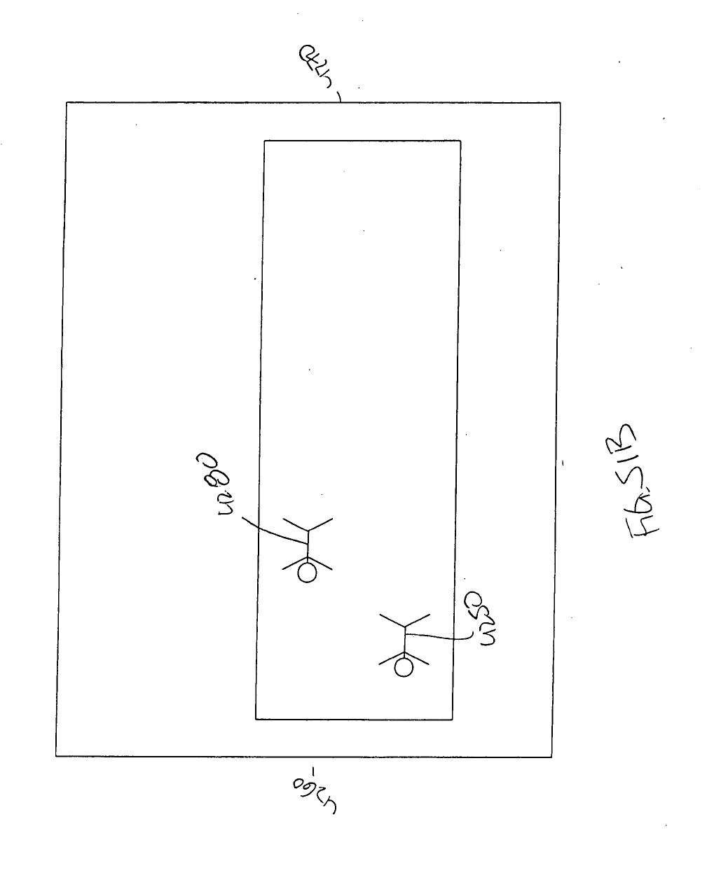

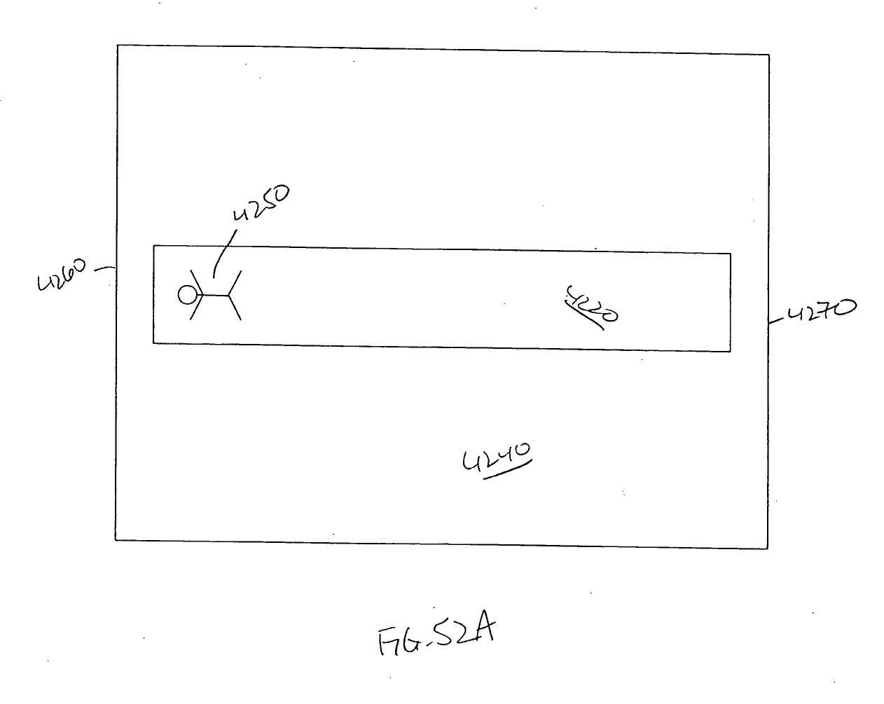

FIGS. 48A through 52A show visual rendition 4250 proceeding from side 4270 to side 4260. Using Applicant's apparatus and method, the swimmer attempts to maintain that pre-determined rate visually provided by the moving visual rendition 4250. Once again, the swimmer is continuously provided with a visual picture of where he/she, as well as where he/she should be at the selected swimming rate.

The illustrated embodiments of FIGS. 43B through 48B show visual renditions 4250 and 4280 displayed on visual display device 4220 as a swimmer progresses from side 4260 to side 4270. FIGS. 48B through 52B show visual renditions 4250 and 4280 proceeding from side 4270 to side 4260. Rendition 4250 indicates an imaginary swimmer (competitor), while rendition 4280 indicates the actual swimmer.

Both renditions 4250 and 4280 are display device generated images. As those skilled in the art will appreciate, many competition pools have a moveable pool-side camera that is moved along the pool side at the same rate as a swimmer. Rendition 4280 comprises the digitized image from such a pool-side camera. As illustrated in FIGS. 43B through 52B, Applicant's apparatus and method cause visual rendition 4250 to progress along display device 4220 at a pre-determined rate. The swimmer, indicated by visual rendition 4280, attempts to maintain that same pre-determined rate. The swimmer is continuously provided with a visual picture of where he/she is, as well as where he/she should be at the selected rate.

In addition to displaying visual renditions 4250 and 4280, Applicant's visual display device 4220 can also display information comprising text and/or images. In certain embodiments, the displayed information comprises data regarding a training event in progress, such as without limitation the best times recorded during the event, data pertaining to the next opposing swimmer, and the like.

In certain embodiments, the displayed information comprises advertising information. In embodiments wherein Applicant's pool is located at a hotel, spa, resort, or the like, and wherein the displayed information may comprise advertising relating to various amenities offered by the hotel/spa/resort, such as without limitation restaurants, live entertainment available, and the like.

In certain embodiments, Applicant's method further comprises using a plurality of visual display devices 4220 disposed on each of the sides and the bottom of the pool to produce a three-dimensional display. In certain of these embodiments, Applicant's three-dimensional display is used to display an underwater video game.

In certain embodiments, Applicant's method comprises using a plurality of visual display devices 4220 disposed on each of the sides and the bottom of the pool to produce a three-dimensional display. In certain embodiments, that three-dimensional visual display is used in combination with a plurality of speakers. In certain embodiments, one or more of that plurality of speakers are disposed underwater. In certain embodiments, Applicant's method is used to display an underwater, three-dimensional, audio/visual presentation. In certain embodiments, such an audio/visual presentation comprises a television show.

In certain embodiments, such an audio/visual presentation is driven by the streaming output from a DVD player, wherein that streaming output comprises a plurality of audio signals and a plurality of video signals. In certain embodiments, Applicant's method generates a plurality of sounds from the plurality of speakers using the plurality of audio signals, and displays a plurality of images on said visual display device using said plurality of video signals.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to display visual information in a swimming pool at least partially filled with water, comprising the steps of:
disposing a plurality of light emitting devices on a surface of a swimming pool comprising a length, a plurality of sides and a bottom, wherein said surface is selected from the group consisting of one or more of said plurality of sides and said bottom;
sequentially energizing one or more of said light emitting devices.

2. The method of claim 1, wherein said plurality of light emitting devices comprise (N) light emitting devices, further comprising the steps of:
creating a training regime whereunder a swimmer swims said length in a defined time interval (T);
energizing the (i)th light emitting device, wherein (i) is initially set to 1 for a time interval equal to (T)/(N);
determining if (i) equals (N);
operative if (i) does not equal (N), incrementing (i) by unity and repeating said energizing and said determining steps.

3. The method of claim 2, wherein each of said light emitting devices comprises:
a first lens facing a first direction and comprising a first color;
a second lens facing a second direction and comprising a second color, wherein said second direction is opposite said first direction, and wherein said second color differs from said first color.

4. The method of claim 3, wherein said first color is red and wherein said second color is green.

5. The method of claim 3, wherein each of said light emitting devices comprises a water-tight enclosure.

6. The method of claim 5, wherein each of said light-emitting devices comprises a buoy which floats on water.

7. The method of claim 3, wherein each of said light emitting devices comprises a third lens facing a third direction and comprising a third color, wherein said third direction is orthogonal from both said first direction and said second direction, and wherein said third color differs from said first color and from said second color.

8. The method of claim 5, wherein said first color is red and wherein said second color is green and wherein said third color is white.

9. The method of claim 8, wherein each of said light emitting devices comprises a water-tight enclosure.

10. The method of claim 9, wherein each of said light-emitting devices comprises a buoy which floats on water.

11. The method of claim 1, wherein said disposing step further comprises supplying a visual display device comprising an integral unit comprising a plurality of visual light emitting devices.

12. The method of claim 11, further comprising the step of:
displaying a moving rendition of a swimmer on said visual display device.

13. The method of claim 11, further comprising the step of displaying textual information on said visual display device.

14. The method of claim 13, further comprising the step of displaying advertising information on said visual display device.

15. The method of claim 14, wherein said pool is located at a hotel, and wherein said advertising information comprises information relating to restaurants located at said hotel.

16. The method of claim 14, wherein said pool is located at a hotel, and wherein said advertising information comprises information relating to live entertainment available at said hotel.

17. The method of claim 11, wherein said visual display device is disposed on each of said plurality of sides and on said bottom, further comprising the step of displaying an underwater video game on said visual display.

18. The method of claim 17, further comprising the steps of:
supplying a plurality of audio speakers;
using said plurality of speakers and said visual display device to display an audio/visual presentation.

19. The method of claim 18, wherein said displaying an audio/visual presentation step further comprises the steps of:
supplying a DVD player;
generating a streaming output from said DVD player, wherein said streaming output comprises a plurality of audio signals and a plurality of video signals;
generating sounds from said plurality of speakers using said plurality of audio signals;
displaying a images on said visual display device using said plurality of video signals.

20. The method of claim 19, further comprising the step of disposing one or more of said plurality of speakers under water.
